(19) United States
(12) Patent Application Publication
(10) Pub. No.: US 2021/0135292 A1
(43) Pub. Date: May 6, 2021

(54) ALL SULFIDE ELECTROCHEMICAL CELL

(71) Applicant: QUANTUMSCAPE CORPORATION, San Jose, CA (US)

(72) Inventors: Tim HOLME, Mountain View, CA (US); Sunil MAIR, San Jose, CA (US)

(21) Appl. No.: 17/251,741

(22) PCT Filed: Jun. 14, 2019
(86) PCT No.: PCT/US2019/037372

§ 371 Date: Dec. 11, 2020

Related U.S. Application Data
(60) Provisional application No. 62/685,862, filed on Jun. 15, 2018.

(51) Int. Cl. H01M 10/0585; H01M 10/04; H01M 4/38; H01M 10/052; H01M 10/0562; H01M 4/505; H01M 4/525

(52) U.S. Cl. CPC H01M 10/0585; H01M 10/0468; H01M 4/382; H01M 10/052; H01M 10/0562; H01M 2004/021; H01M 4/505; H01M 4/525; H01M 2220/20; H01M 2300/0068; H01M 10/0477

(57) ABSTRACT

Provided herein are processes for making, and methods of using, solid-state batteries which include sulfide electrolytes in the solid-state separator and in the cathode as a catholyte. The process comprises providing at least two layered stacks, and compressing the at least two layered stacks at a pressure between 30 and 5000 MPa and at a temperature of 50° C. to 250° C. Also set forth herein are electrochemical cells and devices made by these processes.

### CROSS-REFERENCE TO RELATED APPLICATIONS

This application claims the benefit of priority to U.S. Provisional Patent Application No. 62/685,862, filed Jun. 15, 2018, and titled ALL SULFIDE ELECTROCHEMICAL CELL, the entire contents of which are herein incorporated by reference in their entirety for all purposes.

### FIELD

The present disclosure concerns solid-state rechargeable batteries, which are also known as secondary batteries.

### BACKGROUND

Solid-state rechargeable batteries are advantageous over commercially available rechargeable batteries based on metrics such as safety and energy density. However, commercialization and large-scale manufacturing challenges remain. A sufficiently high throughput, low cost, scalable process for making solid-state batteries is an unmet need in the relevant field.

### SUMMARY

In one embodiment, set forth herein is a process for making a solid-state battery. The process includes providing at least two layered stacks; wherein each layered stack, individually in each instance, includes a current collector layer having exposed tabs and at least one member selected from the group consisting of a positive electrode layer and a solid-state separator layer; and compressing the at least two layered stacks at a pressure in the range of 30 MPa to 5000 MPa and at a temperature of 50° C. to 250° C.

In a second embodiment, set forth herein is a solid-state battery made by a process set forth herein.

### BRIEF DESCRIPTIONS OF THE DRAWINGS

FIG. 1 is an illustration useful for describing an embodiment of a process herein.

FIG. 2 shows a focused ion beam scanning electron microscopy image of a multilayered electrochemical cell made in Example 1.

FIG. 3 shows a focused ion beam scanning electron microscopy image of an interface between a positive electrode layer and a solid-state separator electrolyte in an electrochemical cell made in Example 1.

FIG. 4 shows the results of electrochemically cycling the electrochemical cell in Example 2 as Voltage (V versus Li metal at 0V) as a function of run charge density (mAh/cm²).

FIG. 5 shows the results of electrochemically cycling the electrochemical cell in Example 2 as Voltage (V versus Li metal at 0V) as a function of run charge density (mAh/cm²).

FIG. 6 shows the results of electrochemically cycling the electrochemical cell in Example 2 as discharge capacity (%) as a function of charge/discharge cycle number.

FIG. 7 shows the results of electrochemically cycling the electrochemical cell in Example 2 as normalized discharge energy as a function of discharge C-rate.

### DETAILED DESCRIPTION

Definitions

As used herein, the term “about,” when qualifying a number, e.g., about 15% w/w, refers to the number qualified and optionally the numbers included in a range about that qualified number that includes ±10% of the number. For example, about 15 w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, “PSI” and “kPSI” refer to pounds-per-square inch and kilo-pounds-per-square inch, respectively. One of skill in the relevant art will be able to convert any pressure recited herein, which is stated in PSI or kPSI united, into an equivalent pressure using alternative units. For example, 1 kPSI is equivalent to 6.89476 MPa, wherein MPa refers to mega-Pascals. Alternatively, 1 PSI is equivalent to 0.00689476 Megapascals. 101325 Pa or 0.101325 MPa are equivalent to 1 atmosphere (atm), which is also equivalent to 14.6959 pounds-per-square inch.

As used herein, the phrase “active material,” refers to a material that intercalates, or converts with, lithium in a reversible reaction such that the active material is suitable for use in a rechargeable battery. Active materials may include intercalation materials such as NCA or NMC. Active materials may include conversion chemistry materials such as FeF₃. For example, active materials may include, but are not limited to, any active material set forth in US US20160211517A1, which published Jul. 21, 2016, and is titled LITHIUM RICH NICKEL MANGANESE COBALT OXIDE.

As used herein, the phrase “current collector” refers to a component or layer in a secondary battery through which electrons conduct, to or from an electrode in order to complete an external circuit, and which are in direct contact with the electrode to or from which the electrons conduct. In some examples, the current collector is a metal (e.g., Al, Cu, or Ni, steel, alloys thereof, or combinations thereof) layer which is laminated to a positive or negative electrode. In some examples, the current collector is Al. In some examples, the current collector is Cu. In some examples, the current collector is Ni. In some examples, the current collector is steel. In some examples, the current collector is an alloy of Al. In some examples, the current collector is an alloy of Cu. In some examples, the current collector is an alloy of steel. In some examples, the current collector is Al. In some examples, the current collector is coated with carbon. In some examples, the current collector comprises a combination of the above metals. During charging and discharging, electrons conduct through the current collector when entering or exiting an electrode.

As used herein, the term “diameter (d₉₀)” refers to the size, in a distribution of sizes, measured by microscopy techniques or other particle size analysis techniques, including, but not limited to, scanning electron microscopy or dynamic light scattering. D₉₀ includes the characteristic dimension, i.e. , particle size, at which 90% of the total particle area (for a 2D sampling method like microscopy) or volume (for a 3D sampling method like light scattering) is representative of particles smaller than the recited size. In other words, in a collection of particle sizes, d₉₀ indicates the size at which 90% of the particles in the collection have a size smaller than the recited size. Similarly, the term “diameter (d₅₀)” includes the characteristic dimension at which 50% of the total particle area (or volume) is representative of particles smaller than the recited size. Similarly, the term “diameter (d₁₀)” includes the characteristic dimension at which 10% of the total particle area (or volume) is representative of particles smaller than the recited size. These figures may be calculated on a per-volume or per-area basis. Per-volume basis is assumed if neither is explicitly recited.

As used herein, the phrases “electrochemical cell” or “battery cell” shall mean a single cell including a positive electrode and a negative electrode, which have ionic communication between the two by way of an electrolyte. Unless specific to the contrary, the electrolyte is an solid-state electrolyte. In some examples, the electrolyte includes a solid-state electrolyte in addition to a liquid electrolyte and/or a gel electrolyte. In some embodiments, the same battery cell includes multiple positive electrodes and/or multiple negative electrodes enclosed in one container.

As used herein, the term “contact” means direct contact unless specified otherwise. For electrically conductive materials, contact means contact sufficient for electrical conduction to occur between the contacting materials. For ionically conductive materials, contact means contact sufficient for ionic conduction to occur between the contacting materials. Two materials which are in direct contact are positioned without an interleaving layer between the two materials. As used herein, the phrase “electrical contact,” refers to contact sufficient for electrical conduction to occur between the contacting materials. Direct contact between two materials, one of which is electrically or ionically insulating, means that the two materials share an interface that transmits an applied force or pressure.

As used herein, the phrase “electrical contact” means that two materials are in direct contact and can conduct an electrical current through the point(s) of direct contact.

As used herein, the phrase “electrochemical device” refers to an energy storage device, such as, but not limited to a Li-secondary battery that operates or produces electricity or an electrical current by an electrochemical reaction, e.g., a conversion chemistry reaction such as 3Li+FeF₃↔3LiF+Fe. Electrochemical devices include those that operate or produce electricity or an electrical current by an intercalation chemistry electrochemical reaction, such as but not limited to the Li intercalation reactions that occur with cathode active materials, such as but not limited to cobalt oxide, nickel-cobalt-aluminum oxide (NCA), nickel-manganese-cobalt oxide (NMC), lithium iron phosphate (LFP), and lithium titanate (LTO) cathode active materials.

As used herein, the term “electrochemical stack,” refers to at least a positive electrode, a negative electrode current collector, and a solid-state electrolyte positioned between the positive electrode and negative electrode current collector. In some examples, a stack includes a series of repeating layers of positive electrodes, solid separators, and negative electrode current collectors. An electrochemical stack may also include a positive electrode current collector. An electrochemical stack may also include a negative electrode such as, but not limited to, a lithium metal negative electrode.

As used herein, the term “layered stack” refers to a stack including at least a current collector and either a solid-state separator or a positive electrode.

As used herein the phrase, “high throughput,” refers to the production rate (number of units produced over a given time frame) in a process that suitable for use in commercial manufacturing of solid-state batteries. For example, a high throughput process for making solid-state electrolytes includes one that produces at least one thousand (1,000) solid-state electrolytes per week.

As used herein, the terms “cathode” and “anode” refer to the electrodes of a battery. During a charge cycle in a Li-secondary battery, Li ions leave the cathode and move through an electrolyte and to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode.

As used herein, the term “negative electrode,” refers to a lithium metal negative electrode unless specified otherwise to the contrary.

As used herein, the term “a positive electrode,” refers to the portion of an electrochemical cell to which ions and electrons flow during discharge of the electrochemical cell.

As used herein, the term “electrolyte,” refers to a material that allows ions, e.g., Li⁺, to migrate therethrough, but which does not allow electrons to conduct therethrough. The ionic conductivity is greater than the electronic conductivity by a factor of at least 1000. Electrolytes are useful for electrically insulating the cathode and anode of a secondary battery while allowing ions, e.g., Li⁺, to transmit through the electrolyte. Solid electrolytes, in some examples, rely on ion hopping and/or diffusion through rigid structures. Solid electrolytes may be also referred to as fast ion conductors or super-ionic conductors. In this case, a solid electrolyte layer may be also referred to as a solid electrolyte separator or a solid-state electrolyte separator.

As used herein, the term “catholyte,” refers to an electrolyte that is intimately mixed with, or surrounded by, a cathode (i.e., positive electrode) active material (e.g., a metal fluoride optionally including lithium).

As used herein, the term “solid-state electrolyte,” refers to an electrolyte, as defined herein, wherein the electrolyte is a solid.

As used herein, the terms “separator,” and “Li⁺ ion-conducting separator,” are used interchangeably with separator being a short-hand reference for Li⁺ ion-conducting separator, unless specified otherwise explicitly. A separator refers to an solid-state electrolyte, which conducts Li⁺ ions, is substantially insulating to electrons, and is suitable for use as a physical barrier or spacer between the positive and negative electrodes in an electrochemical cell or a rechargeable battery. A separator, as used herein, is substantially insulating to electrons. A separator's lithium ion conductivity is at least 10³ times, and typically 10⁶ times, greater than the separator's electron conductivity.

As used herein, the term “rational number” refers to any number which can be expressed as the quotient or fraction (e.g., p/q) of two integers (e.g., p and q), with the denominator (e.g., q) not equal to zero. Example rational numbers include, but are not limited to, 1, 1.1, 1.52, 2, 2.5, 3, 3.12, and 7.

Unless specified to the contrary, subscripts and molar coefficients in empirical formulae are based on the quantities of raw materials initially batched to make the material described. For example, for the material, Li₇La₃Zr₂O₁₂·0.35Al₂O₃, the subscripts, 7, 3, 2, 12, and the coefficient, 0.35, refer to the respective elemental ratios in the chemical precursors (e.g., LiOH, La₂O₃, ZrO₂, Al₂O₃) used to prepare the Li₇La₃Zr₂O₁₂·0.35Al₂O₃. As used herein, the ratios are molar ratios unless specified to the contrary.

As used herein, the phrase “lithium-stuffed garnet” refers to oxides that are characterized by a crystal structure related to a garnet crystal structure. Some examples of lithium-stuffed garnets are set forth in U.S. Patent Application Publication No. 2015/0099190, which published Apr. 9, 2015, and was filed Oct. 7, 2014 as Ser. No. 14/509,029, and is incorporated by reference herein in its entirety for all purposes. This application describes Li-stuffed garnet solid-state electrolytes used in solid-state lithium rechargeable batteries. These Li-stuffed garnets generally having a composition according to Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E<3, 10<F<13, and M′ and M″ are each, independently in each instance selected from Ga, Al, Mo, W, Nb, Sb, Ca, Ba, Sr, Ce, Hf, Rb, and Ta, or LiₐLa_{b}Zr_{c}Al_{d}Me′ₑO_{f}, wherein 5<a<8.5; 2<b<4; 0<c≤2.5; 0≤d<2; 0≤e<2, and 10<f<13 and Me′ is a metal selected from Ga, Nb, Ta, V, W, Mo, and Sb and as otherwise described in U.S. Patent Application Publication No. 2015/0099190. As used herein, lithium-stuffed garnets, and garnets, generally, include, but are not limited to, Li_{7.0±δ}La₃(Zrₜ₁+Nbₜ₂+Taₜ₃)O₁₂+0.35Al₂O₃; wherein δ is from 0 to 3 and (t1+t2+t3=2) so that the La:(Zr/Nb/Ta) ratio is 3:2. For example, δ is 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0. In some examples, the Li-stuffed garnet herein has a composition of Li_{7±δ}Li₃Zr₂O₁₂·xAl₂O₃. In yet another embodiment, the Li-stuffed garnet herein has a composition of Li_{7±δ}Li₃Zr₂O₁₂·0.22Al₂O₃. In yet other examples, the Li-stuffed garnet herein has a composition of Li_{7±δ}Li₃Zr₂O₁₂·0.35Al₂O₃. In certain other examples, the Li-stuffed garnet herein has a composition of Li_{7±δ}Li₃Zr₂O₁₂·0.5Al₂O₃. In another example, the Li-stuffed garnet herein has a composition of Li_{7±δ}Li₃Zr₂O₁₂·0.75Al₂O₃. Also, L-stuffed garnets used herein include, but are not limited to, LiₓLa₃Zr₂O_{F}+yAl₂O₃, wherein x ranges from 5.5 to 9; and y ranges from 0.05 to 1. In these examples, subscripts x, y, and F are selected so that the Li-stuffed garnet is charge neutral. In some examples x is 7 and y is 1.0. In some examples, x is 5 and y is 1.0. In some examples, x is 6 and y is 1.0. In some examples, x is 8 and y is 1.0. In some examples, x is 9 and y is 1.0. In some examples x is 7 and y is 0.35. In some examples, x is 5 and y is 0.35. In some examples, x is 6 and y is 0.35. In some examples, x is 8 and y is 0.35. In some examples, x is 9 and y is 0.35. In some examples x is 7 and y is 0.7. In some examples, x is 5 and y is 0.7. In some examples, x is 6 and y is 0.7. In some examples, x is 8 and y is 0.7. In some examples, x is 9 and y is 0.7. In some examples x is 7 and y is 0.75. In some examples, x is 5 and y is 0.75. In some examples, x is 6 and y is 0.75. In some examples, x is 8 and y is 0.75. In some examples, x is 9 and y is 0.75. In some examples x is 7 and y is 0.8. In some examples, x is 5 and y is 0.8. In some examples, x is 6 and y is 0.8. In some examples, x is 8 and y is 0.8. In some examples, x is 9 and y is 0.8. In some examples x is 7 and y is 0.5. In some examples, x is 5 and y is 0.5. In some examples, x is 6 and y is 0.5. In some examples, x is 8 and y is 0.5. In some examples, x is 9 and y is 0.5. In some examples x is 7 and y is 0.4. In some examples, x is 5 and y is 0.4. In some examples, x is 6 and y is 0.4. In some examples, x is 8 and y is 0.4. In some examples, x is 9 and y is 0.4. In some examples x is 7 and y is 0.3. In some examples, x is 5 and y is 0.3. In some examples, x is 6 and y is 0.3. In some examples, x is 8 and y is 0.3. In some examples, x is 9 and y is 0.3. In some examples x is 7 and y is 0.22. In some examples, x is 5 and y is 0.22. In some examples, x is 6 and y is 0.22. In some examples, x is 8 and y is 0.22. In some examples, x is 9 and y is 0.22. Also, Li-stuffed garnets as used herein include, but are not limited to, LiₓLa₃Zr₂O₁₂+yAl₂O₃, wherein y is from 0 to 1 and includes 0 and 1. In one embodiment, the Li-stuffed garnet herein has a composition of Li₇Li₃Zr₂O₁₂. As used herein, lithium-stuffed garnets may include, but are not limited to, compounds of the formula Li_{A}La_{B}M′_{C}M″_{D}O_{F} where A=6.2. Lithium-stuffed garnets may include, but are not limited to, compounds of the formula Li_{A}La_{B}M′_{C}M″_{D}O_{F} where A=6.3. Lithium-stuffed garnets may include, but are not limited to, compounds of the formula Li_{A}La_{B}M′_{C}M″_{D}O_{F} where A=6.4. Lithium-stuffed garnets may include, but are not limited to, compounds of the formula Li_{A}La_{B}M′_{C}M″_{D}O_{F} where A=6.5. Lithium-stuffed garnets may include, but are not limited to, compounds of the formula Li_{A}La_{B}M′_{C}M″_{D}O_{F} where A=6.6. Lithium-stuffed garnets may include, but are not limited to, compounds of the formula Li_{A}La_{B}M′_{C}M″_{D}O_{F} where A=6.7. Lithium-stuffed garnets may include, but are not limited to, compounds of the formula Li_{A}La_{B}M′_{C}M″_{D}O_{F} where A=6.8. Lithium-stuffed garnets may include, but are not limited to, compounds of the formula Li_{A}La_{B}M′_{C}M″_{D}O_{F} where A=6.9. Lithium-stuffed garnets may include, but are not limited to, compounds of the formula Li_{A}La_{B}M′_{C}M″_{D}O_{F} where A=7.0. Lithium-stuffed garnets may include, but are not limited to, compounds of the formula Li_{A}La_{B}M′_{C}M″_{D}O_{F} where A=7.1. Lithium-stuffed garnets may include, but are not limited to, compounds of the formula Li_{A}La_{B}M′_{C}M″_{D}O_{F} where A=7.2. Lithium-stuffed garnets may include, but are not limited to, compounds of the formula Li_{A}La_{B}M′_{C}M″_{D}O_{F} where B=2.6. Lithium-stuffed garnets may include, but are not limited to, compounds of the formula Li_{A}La_{B}M′_{C}M″_{D}O_{F} where B=2.7. Lithium-stuffed garnets may include, but are not limited to, compounds of the formula Li_{A}La_{B}M′_{C}M″_{D}O_{F} where B=2.8. Lithium-stuffed garnets may include, but are not limited to, compounds of the formula Li_{A}La_{B}M′_{C}M″_{D}O_{F} where B=2.9. Lithium-stuffed garnets may include, but are not limited to, compounds of the formula Li_{A}La_{B}M′_{C}M″_{D}O_{F} where B=3.0. Lithium-stuffed garnets may include, but are not limited to, compounds of the formula Li_{A}La_{B}M′_{C}M″_{D}O_{F} where B=3.1. Lithium-stuffed garnets may include, but are not limited to, compounds of the formula Li_{A}La_{B}M′_{C}M″_{D}O_{F} where B=3.2. Lithium-stuffed garnets may include, but are not limited to, compounds of the formula Li_{A}La_{B}M′_{C}M″_{D}O_{F} where C=0.0. Lithium-stuffed garnets may include, but are not limited to, compounds of the formula Li_{A}La_{B}M′_{C}M″_{D}O_{F} where C=0.1. Lithium-stuffed garnets may include, but are not limited to, compounds of the formula Li_{A}La_{B}M′_{C}M″_{D}O_{F} where C=0.2. Lithium-stuffed garnets may include, but are not limited to, compounds of the formula Li_{A}La_{B}M′_{C}M″_{D}O_{F} where C=0.3. Lithium-stuffed garnets may include, but are not limited to, compounds of the formula Li_{A}La_{B}M′_{C}M″_{D}O_{F} where C=0.4. Lithium-stuffed garnets may include, but are not limited to, compounds of the formula Li_{A}La_{B}M′_{C}M″_{D}O_{F} where C=0.5. Lithium-stuffed garnets may include, but are not limited to, compounds of the formula Li_{A}La_{B}M′_{C}M″_{D}O_{F} where C=0.6. Lithium-stuffed garnets may include, but are not limited to, compounds of the formula Li_{A}La_{B}M′_{C}M″_{D}O_{F} where C=0.7. Lithium-stuffed garnets may include, but are not limited to, compounds of the formula Li_{A}La_{B}M′_{C}M″_{D}O_{F} where C=0.8. Lithium-stuffed garnets may include, but are not limited to, compounds of the formula Li_{A}La_{B}M′_{C}M″_{D}O_{F} where C=0.9. Lithium-stuffed garnets may include, but are not limited to, compounds of the formula Li_{A}La_{B}M′_{C}M″_{D}O_{F} where C=1.0. Lithium-stuffed garnets may include, but are not limited to, compounds of the formula Li_{A}La_{B}M′_{C}M″_{D}O_{F} where C=1.1. Lithium-stuffed garnets may include, but are not limited to, compounds of the formula Li_{A}La_{B}M′_{C}M″_{D}O_{F} where C=1.2. Lithium-stuffed garnets may include, but are not limited to, compounds of the formula Li_{A}La_{B}M′_{C}M″_{D}O_{F} where C=1.3. Lithium-stuffed garnets may include, but are not limited to, compounds of the formula Li_{A}La_{B}M′_{C}M″_{D}O_{F} where C=1.4. Lithium-stuffed garnets may include, but are not limited to, compounds of the formula Li_{A}La_{B}M′_{C}M″_{D}O_{F} where D=0.0. Lithium-stuffed garnets may include, but are not limited to, compounds of the formula Li_{A}La_{B}M′_{C}M″_{D}O_{F} where D=0.1. Lithium-stuffed garnets may include, but are not limited to, compounds of the formula Li_{A}La_{B}M′_{C}M″_{D}O_{F} where D=0.2. Lithium-stuffed garnets may include, but are not limited to, compounds of the formula Li_{A}La_{B}M′_{C}M″_{D}O_{F} where D=0.3. Lithium-stuffed garnets may include, but are not limited to, compounds of the formula Li_{A}La_{B}M′_{C}M″_{D}O_{F} where D=0.4. Lithium-stuffed garnets may include, but are not limited to, compounds of the formula Li_{A}La_{B}M′_{C}M″_{D}O_{F} where D=0.5. Lithium-stuffed garnets may include, but are not limited to, compounds of the formula Li_{A}La_{B}M′_{C}M″_{D}O_{F} where D=0.6. Lithium-stuffed garnets may include, but are not limited to, compounds of the formula Li_{A}La_{B}M′_{C}M″_{D}O_{F} where D=0.7. Lithium-stuffed garnets may include, but are not limited to, compounds of the formula Li_{A}La_{B}M′_{C}M″_{D}O_{F} where D=0.8. Lithium-stuffed garnets may include, but are not limited to, compounds of the formula Li_{A}La_{B}M′_{C}M″_{D}O_{F} where D=0.9. Lithium-stuffed garnets may include, but are not limited to, compounds of the formula Li_{A}La_{B}M′_{C}M″_{D}O_{F} where F=11.8. Lithium-stuffed garnets may include, but are not limited to, compounds of the formula Li_{A}La_{B}M′_{C}M″_{D}O_{F} where F=11.9. Lithium-stuffed garnets may include, but are not limited to, compounds of the formula Li_{A}La_{B}M′_{C}M″_{D}O_{F} where F=12.0. Lithium-stuffed garnets may include, but are not limited to, compounds of the formula Li_{A}La_{B}M′_{C}M″_{D}O_{F} where F=12.1. Lithium-stuffed garnets may include, but are not limited to, compounds of the formula Li_{A}La_{B}M′_{C}M″_{D}O_{F} where F=12.2. Lithium-stuffed garnets may include, but are not limited to, compounds of the formula Li_{A}La_{B}M′_{C}M″_{D}Zr_{E}O_{F} where A=6.3. Lithium-stuffed garnets may include, but are not limited to, compounds of the formula Li_{A}La_{B}M′_{C}M″_{D}Zr_{E}O_{F} where A=6.4. Lithium-stuffed garnets may include, but are not limited to, compounds of the formula Li_{A}La_{B}M′_{C}M″_{D}Zr_{E}O_{F} where A=6.5. Lithium-stuffed garnets may include, but are not limited to, compounds of the formula Li_{A}La_{B}M′_{C}M″_{D}Zr_{E}O_{F} where A=6.6. Lithium-stuffed garnets may include, but are not limited to, compounds of the formula Li_{A}La_{B}M′_{C}M″_{D}Zr_{E}O_{F} where A=6.7. Lithium-stuffed garnets may include, but are not limited to, compounds of the formula Li_{A}La_{B}M′_{C}M″_{D}Zr_{E}O_{F} where A=6.8. Lithium-stuffed garnets may include, but are not limited to, compounds of the formula Li_{A}La_{B}M′_{C}M″_{D}Zr_{E}O_{F} where A=6.9. Lithium-stuffed garnets may include, but are not limited to, compounds of the formula Li_{A}La_{B}M′_{C}M″_{D}Zr_{E}O_{F} where A=7.0. Lithium-stuffed garnets may include, but are not limited to, compounds of the formula Li_{A}La_{B}M′_{C}M″_{D}Zr_{E}O_{F} where A=7.1. Lithium-stuffed garnets may include, but are not limited to, compounds of the formula Li_{A}La_{B}M′_{C}M″_{D}Zr_{E}O_{F} where A=7.2. Lithium-stuffed garnets may include, but are not limited to, compounds of the formula Li_{A}La_{B}M′_{C}M″_{D}Zr_{E}O_{F} where B=2.6. Lithium-stuffed garnets may include, but are not limited to, compounds of the formula Li_{A}La_{B}M′_{C}M″_{D}Zr_{E}O_{F} where B=2.7. Lithium-stuffed garnets may include, but are not limited to, compounds of the formula Li_{A}La_{B}M′_{C}M″_{D}Zr_{E}O_{F} where B=2.8. Lithium-stuffed garnets may include, but are not limited to, compounds of the formula Li_{A}La_{B}M′_{C}M″_{D}Zr_{E}O_{F} where B=2.9. Lithium-stuffed garnets may include, but are not limited to, compounds of the formula Li_{A}La_{B}M′_{C}M″_{D}Zr_{E}O_{F} where B=3.0. Lithium-stuffed garnets may include, but are not limited to, compounds of the formula Li_{A}La_{B}M′_{C}M″_{D}Zr_{E}O_{F} where B=3.1. Lithium-stuffed garnets may include, but are not limited to, compounds of the formula Li_{A}La_{B}M′_{C}M″_{D}Zr_{E}O_{F} where B=3.2. Lithium-stuffed garnets may include, but are not limited to, compounds of the formula Li_{A}La_{B}M′_{C}M″_{D}Zr_{E}O_{F} where C=0.0. Lithium-stuffed garnets may include, but are not limited to, compounds of the formula Li_{A}La_{B}M′_{C}M″_{D}Zr_{E}O_{F} where C=0.1. Lithium-stuffed garnets may include, but are not limited to, compounds of the formula Li_{A}La_{B}M′_{C}M″_{D}Zr_{E}O_{F} where C=0.2. Lithium-stuffed garnets may include, but are not limited to, compounds of the formula Li_{A}La_{B}M′_{C}M″_{D}Zr_{E}O_{F} where C=0.3. Lithium-stuffed garnets may include, but are not limited to, compounds of the formula Li_{A}La_{B}M′_{C}M″_{D}Zr_{E}O_{F} where C=0.4. Lithium-stuffed garnets may include, but are not limited to, compounds of the formula Li_{A}La_{B}M′_{C}M″_{D}Zr_{E}O_{F} where C=0.5. Lithium-stuffed garnets may include, but are not limited to, compounds of the formula Li_{A}La_{B}M′_{C}M″_{D}Zr_{E}O_{F} where C=0.6. Lithium-stuffed garnets may include, but are not limited to, compounds of the formula Li_{A}La_{B}M′_{C}M″_{D}Zr_{E}O_{F} where C=0.7. Lithium-stuffed garnets may include, but are not limited to, compounds of the formula Li_{A}La_{B}M′_{C}M″_{D}Zr_{E}O_{F} where C=0.8. Lithium-stuffed garnets may include, but are not limited to, compounds of the formula Li_{A}La_{B}M′_{C}M″_{D}Zr_{E}O_{F} where C=0.9. Lithium-stuffed garnets may include, but are not limited to, compounds of the formula Li_{A}La_{B}M′_{C}M″_{D}Zr_{E}O_{F} where C=1.0. Lithium-stuffed garnets may include, but are not limited to, compounds of the formula Li_{A}La_{B}M′_{C}M″_{D}Zr_{E}O_{F} where C=1.1. Lithium-stuffed garnets may include, but are not limited to, compounds of the formula Li_{A}La_{B}M′_{C}M″_{D}Zr_{E}O_{F} where C=1.2. Lithium-stuffed garnets may include, but are not limited to, compounds of the formula Li_{A}La_{B}M′_{C}M″_{D}Zr_{E}O_{F} where C=1.3. Lithium-stuffed garnets may include, but are not limited to, compounds of the formula Li_{A}La_{B}M′_{C}M″_{D}Zr_{E}O_{F} where C=1.4. Lithium-stuffed garnets may include, but are not limited to, compounds of the formula Li_{A}La_{B}M′_{C}M″_{D}Zr_{E}O_{F} where D=0.0. Lithium-stuffed garnets may include, but are not limited to, compounds of the formula Li_{A}La_{B}M′_{C}M″_{D}Zr_{E}O_{F} where D=0.1. Lithium-stuffed garnets may include, but are not limited to, compounds of the formula Li_{A}La_{B}M′_{C}M″_{D}Zr_{E}O_{F} where D=0.2. Lithium-stuffed garnets may include, but are not limited to, compounds of the formula Li_{A}La_{B}M′_{C}M″_{D}Zr_{E}O_{F} where D=0.3. Lithium-stuffed garnets may include, but are not limited to, compounds of the formula Li_{A}La_{B}M′_{C}M″_{D}Zr_{E}O_{F} where D=0.4. Lithium-stuffed garnets may include, but are not limited to, compounds of the formula Li_{A}La_{B}M′_{C}M″_{D}Zr_{E}O_{F} where D=0.5. Lithium-stuffed garnets may include, but are not limited to, compounds of the formula Li_{A}La_{B}M′_{C}M″_{D}Zr_{E}O_{F} where D=0.6. Lithium-stuffed garnets may include, but are not limited to, compounds of the formula Li_{A}La_{B}M′_{C}M″_{D}Zr_{E}O_{F} where D=0.7. Lithium-stuffed garnets may include, but are not limited to, compounds of the formula Li_{A}La_{B}M′_{C}M″_{D}Zr_{E}O_{F} where D=0.8. Lithium-stuffed garnets may include, but are not limited to, compounds of the formula Li_{A}La_{B}M′_{C}M″_{D}Zr_{E}O_{F} where D=0.9. Lithium-stuffed garnets may include, but are not limited to, compounds of the formula Li_{A}La_{B}M′_{C}M″_{D}Zr_{E}O_{F} where F=11.8. Lithium-stuffed garnets may include, but are not limited to, compounds of the formula Li_{A}La_{B}M′_{C}M″_{D}Zr_{E}O_{F} where F=11.9. Lithium-stuffed garnets may include, but are not limited to, compounds of the formula Li_{A}La_{B}M′_{C}M″_{D}Zr_{E}O_{F} where F=12.0. Lithium-stuffed garnets may include, but are not limited to, compounds of the formula Li_{A}La_{B}M′_{C}M″_{D}Zr_{E}O_{F} where F=12.1. Lithium-stuffed garnets may include, but are not limited to, compounds of the formula Li_{A}La_{B}M′_{C}M″_{D}Zr_{E}O_{F} where F=12.2. Lithium-stuffed garnets may include, but are not limited to, compounds of the formula Li_{A}La_{B}M′_{C}M″_{D}Zr_{E}O_{F} where E=1.1. Lithium-stuffed garnets may include, but are not limited to, compounds of the formula Li_{A}La_{B}M′_{C}M″_{D}Zr_{E}O_{F} where E=1.2. Lithium-stuffed garnets may include, but are not limited to, compounds of the formula Li_{A}La_{B}M′_{C}M″_{D}Zr_{E}O_{F} where E=1.3. Lithium-stuffed garnets may include, but are not limited to, compounds of the formula Li_{A}La_{B}M′_{C}M″_{D}Zr_{E}O_{F} where E=1.4. Lithium-stuffed garnets may include, but are not limited to, compounds of the formula Li_{A}La_{B}M′_{C}M″_{D}Zr_{E}O_{F} where E=1.5. Lithium-stuffed garnets may include, but are not limited to, compounds of the formula Li_{A}La_{B}M′_{C}M″_{D}Zr_{E}O_{F} where E=1.6. Lithium-stuffed garnets may include, but are not limited to, compounds of the formula Li_{A}La_{B}M′_{C}M″_{D}Zr_{E}O_{F} where E=1.7. Lithium-stuffed garnets may include, but are not limited to, compounds of the formula Li_{A}La_{B}M′_{C}M″_{D}Zr_{E}O_{F} where E=1.8. Lithium-stuffed garnets may include, but are not limited to, compounds of the formula Li_{A}La_{B}M′_{C}M″_{D}Zr_{E}O_{F} where E=1.9. Lithium-stuffed garnets may include, but are not limited to, compounds of the formula Li_{A}La_{B}M′_{C}M″_{D}Zr_{E}O_{F} where E=2.0. Lithium-stuffed garnets may include, but are not limited to, compounds of the formula Li_{A}La_{B}M′_{C}M″_{D}Zr_{E}O_{F} where E=2.1.

As used herein, garnet or Li-stuffed garnet does not include YAG-garnets (i.e., yttrium aluminum garnets or, e.g., Y₃Al₅O₁₂). As used herein, garnet does not include silicate-based garnets such as pyrope, almandine, spessartine grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used here, the phrase “sulfide electrolyte,” or “lithium sulfide” includes, but is not limited to, electrolytes referred to herein as LSS, LTS, LXPS, or LXPSO, where X is Si, Ge, Sn, As, Al, or Li—Sn—Si—P—S, or Li—As—Sn—S. In these acronyms (LSS, LTS, LXPS, or LXPSO), S refers to the element S, Si, or combinations thereof, and T refers to the element Sn. “Sulfide electrolyte” may also include LiₐP_{b}S_{c}X_{d}, LiₐB_{b}S_{c}X_{d}, LiₐSn_{b}S_{c}X_{d} or LiₐSi_{b}S_{c}X_{d} where X═F, Cl, Br, I, and 10%≤a≤50%, 10%≤b≤44%, 24%≤c≤70%, 0≤d≤18%. Up to 10 at % oxygen may be present in the sulfide electrolytes, either by design or as a contaminant species.

As used herein, the phrase “polymer-sulfide composite,” refers to a material that includes both a polymer and a sulfide material, as set forth herein. Example polymer-sulfide composite are described in US Patent Application Publication No. US20170005367, filed as U.S. patent application Ser. No. 15/192,960, on Jun. 24, 2016, the entire contents of which are herein incorporated by reference in their entirety for all purposes.

As used here, the phrase “sulfide single ion conductor,” refers to a sulfide electrolyte that only conducts a single ion, e.g., Li⁺.

As used herein, “SLOPS” includes, unless otherwise specified, a 60:40 molar ratio of Li₂S:SiS₂ with 0.1-10 mol. % Li₃PO₄. In some examples, “SLOPS” includes Li₁₀Si₄S₁₃ (50:50 Li₂S:SiS₂) with 0.1-10 mol. % Li₃PO₄. In some examples, “SLOPS” includes Li₂₆Si₇S₂₇ (65:35 Li₂S:SiS₂) with 0.1-10 mol. % Li₃PO₄. In some examples, “SLOPS” includes Li₄SiS₄ (67:33 Li₂S:SiS₂) with 0.1-5 mol. % Li₃PO₄. In some examples, “SLOPS” includes Li₁₄Si₃S₁₃ (70:30 Li₂S:SiS₂) with 0.1-5 mol. % Li₃PO₄. In some examples, “SLOPS” is characterized by the formula (1−x)(60:40 Li₂S:SiS₂)*(x)(Li₃PO₄), wherein x is from 0.01 to 0.99. As used herein, “LBS-PDX” refers to an electrolyte composition of Li₂S:B₂S₃:Li₃PO₄:LiX where X is a halogen (X═F, Cl, Br, I). The composition can include Li₃BS₃ or Li₅B₇S₁₃ doped with 0-30% lithium halide such as LiI and/or 0-10% Li₃PO₄.

As used here, “LSS” refers to lithium silicon sulfide which can be described as Li₂S—SiS₂, Li—SiS₂, Li—S—Si, and/or a catholyte consisting essentially of Li, S, and Si. LSS refers to an electrolyte material characterized by the formula LiₓSi_{y}S_{z} where 0.33≤x≤0.5, 0.1≤y≤0.2, 0.4≤z≤0.55, and it may include up to 10 atomic % oxygen. LSS also refers to an electrolyte material including Li, Si, and S. In some examples, LSS is a mixture of Li₂S and SiS₂. In some examples, the ratio of Li₂S:SiS₂ is 90:10, 85:15, 80:20, 75:25, 70:30, 2:1, 65:35, 60:40, 55:45, or 50:50 molar ratio. LSS may be doped with compounds such as LiₓPO_{y}, LiₓBO_{y}, Li₄SiO₄, Li₂O, Li₃MO₄, Li₃MO₃, BSₓ, GeSₓ, GaSₓ, PSₓ, and/or lithium halides such as, but not limited to, LiI, LiCl, LiF, or LiBr, wherein 0<x≤5 and 0<y≤5.

As used here, “LTS” refers to a lithium tin sulfide compound which can be described as Li₂S:SnS₂:As₂S₅, Li₂S—SnS₂, Li₂S—SnS, Li—S—Sn, and/or a catholyte consisting essentially of Li, S, and Sn. The composition may be LiₓSn_{y}S_{z} where 0.25≤x≤0.65, 0.05≤y≤0.2, and 0.25≤x≤0.65. In some examples, LTS is a mixture of Li₂S and SnS₂ in the ratio of 80:20, 75:25, 70:30, 2:1, or 1:1 molar ratio. LTS may include up to 10 atomic % oxygen. LTS may be doped with Bi, Sb, As, P, B, Al, Ge, Ga, and/or In and/or lithium halides such as, but not limited to, LiI, LiCl, LiF, or LiBr. As used herein, “LATS” refers to LTS, as used above, and further including Arsenic (As).

As used here, “LXPS” refers to a material characterized by the formula LiₐMP_{b}S_{c}, where M is Si, Ge, Sn, and/or Al, and where 2≤a≤8, 0.5≤b≤2.5, 4≤c≤12. “LSPS” refers to an electrolyte material characterized by the formula LₐSiP_{b}S_{c}, where 2≤a≤8, 0.5≤b≤2.5, 4≤c≤12. LSPS refers to an electrolyte material characterized by the formula LₐSiP_{b}S_{c}, wherein, where 2≤a≤8, 0.5≤b≤4≤c≤12, d<3. In these examples, the subscripts are selected so that the compound is neutrally charged. Exemplary LXPS materials are found, for example, in International Patent Application Publication No. PCT/US2014/038283, filed May 16, 2014, and titled SOLID STATE CATHOLYTE OR ELECTROLYTE FOR BATTERY USING LI_{A}MP_{B}S_{C} (M═Si, Ge, AND/OR Sn), which is incorporated by reference herein in its entirety. When M is Sn and Si—both are present—the LXPS material is referred to as LSTPS. As used herein, “LSTPSO,” refers to LSTPS that is doped with, or has, O present. In some examples, “LSTPSO,” is a LSTPS material with an oxygen content between 0.01 and 10 atomic %. “LSPS,” refers to an electrolyte material having Li, Si, P, and S chemical constituents. As used herein “LSTPS,” refers to an electrolyte material having Li, Si, P, Sn, and S chemical constituents. As used herein, “LSPSO,” refers to LSPS that is doped with, or has, O present. In some examples, “LSPSO,” is a LSPS material with an oxygen content between 0.01 and 10 atomic %. As used herein, “LATP,” refers to an electrolyte material having Li, As, Sn, and P chemical constituents. As used herein “LAGP,” refers to an electrolyte material having Li, As, Ge, and P chemical constituents. As used herein, “LXPSO” refers to a catholyte material characterized by the formula LiₐMP_{b}S_{c}O_{d}, where M is Si, Ge, Sn, and/or Al, and where 2≤a≤8, 0.5≤b≤2.5, 4≤c≤12, d≤3. LXPSO refers to LXPS, as defined above, and having oxygen doping at from 0.1 to about 10 atomic %. LPSO refers to LPS, as defined above, and having oxygen doping at from 0.1 to about 10 atomic %.

As used here, “LPS,” refers to an electrolyte having Li, P, and S chemical constituents. As used herein, “LPSO,” refers to LPS that is doped with or has O present. In some examples, “LPSO,” is a LPS material with an oxygen content between 0.01 and 10 atomic %. LPS refers to an electrolyte material that can be characterized by the formula LiₓP_{y}S_{z} where 0.33≤x≤0.67, 0.07≤y≤0.2 and 0.4≤z≤0.55. LPS also refers to an electrolyte characterized by a product formed from a mixture of Li₂S:P₂S₅ wherein the molar ratio is 10:1, 9:1, 8:1, 7:1, 6:1 5:1, 4:1, 3:1, 7:3, 2:1, or 1:1. LPS also refers to an electrolyte characterized by a product formed from a mixture of Li₂S:P₂S₅ wherein the reactant or precursor amount of Li₂S is 95 atomic % and P₂S₅ is 5 atomic %. LPS also refers to an electrolyte characterized by a product formed from a mixture of Li₂S:P₂S₅ wherein the reactant or precursor amount of Li₂S is 90 atomic % and P₂S₅ is 10 atomic %. LPS also refers to an electrolyte characterized by a product formed from a mixture of Li₂S:P₂S₅ wherein the reactant or precursor amount of Li₂S is 85 atomic % and P₂S₅ is 15 atomic %. LPS also refers to an electrolyte characterized by a product formed from a mixture of Li₂S:P₂S₅ wherein the reactant or precursor amount of Li₂S is 80 atomic % and P₂S₅ is 20 atomic %. LPS also refers to an electrolyte characterized by a product formed from a mixture of Li₂S:P₂S₅ wherein the reactant or precursor amount of Li₂S is 75 atomic % and P₂S₅ is 25 atomic %. LPS also refers to an electrolyte characterized by a product formed from a mixture of Li₂S:P₂S₅ wherein the reactant or precursor amount of Li₂S is 70 atomic % and P₂S₅ is 30 atomic %. LPS also refers to an electrolyte characterized by a product formed from a mixture of Li₂S:P₂S₅ wherein the reactant or precursor amount of Li₂S is 65 atomic % and P₂S₅ is 35 atomic %. LPS also refers to an electrolyte characterized by a product formed from a mixture of Li₂S:P₂S₅ wherein the reactant or precursor amount of Li₂S is 60 atomic % and P₂S₅ is 40 atomic %. LPS may also be doped with a lithium halide such as LiF, LiCl, LiBr, or LiI at a 0-40% molar content.

As used here, “LBS” refers to an electrolyte material characterized by the formula LiₐB_{b}S_{c} and may include oxygen and/or a lithium halide (LiF, LiCl, LiBr, LiI) at 0-40 mol %.

As used herein, “LSPSCl” refers to an LSPS electrolyte material, as defined above, and further comprising chlorine (Cl). As used herein, “LSPSCl,” refers to LSPS that is doped with, or has, Cl present. In some examples, “LSPSO,” is a LSPS material with a chlorine content between 0.01 and 10 atomic %. An example LSPSCl composition is Li_{9.54}Si_{1.74}Cl_{0.3}P_{1.44}S_{11.7}. In example composition, the LSPSCl includes 39% by mol Li, 7% by mol Si, 1% by mol Cl, 6% by mol P, and 47% by mol S. In an example composition, the LSPSCl includes 12.14% by mass Li, 8.96% by mass Si, 1.95% by mass Cl, 8.18% by mass P, 68.77% by mass S.

As used herein, “LSPSBr” refers to an LSPS electrolyte material, as defined above, and further comprising bromine (Br). As used herein, “LSPSI” refers to an LSPS electrolyte material, as defined above, and further comprising iodine (I).

In some examples, LPS may be further combined with oxides such as LiₓPO_{y}, LiₓBO_{y}, Li₄SiO₄, Li₂O, Li₃MO₄, Li₃MO₃, and/or BSₓ, GeSₓ, GaSₓ, PSₓ.

As used here, “LPSO” refers to an electrolyte material characterized by the formula LiₓP_{y}S_{z}O_{w} where 0.33≤x≤0.67, 0.07≤y≤0.2, 0.4≤z≤0.55, 0≤w≤0.15. Also, LPSO refers to LPS, as defined above, that includes an oxygen content of from 0.01 to 10 atomic %. In some examples, the oxygen content is 1 atomic %. In other examples, the oxygen content is 2 atomic %. In some other examples, the oxygen content is 3 atomic %. In some examples, the oxygen content is 4 atomic %. In other examples, the oxygen content is 5 atomic %. In some other examples, the oxygen content is 6 atomic %. In some examples, the oxygen content is 7 atomic %. In other examples, the oxygen content is 8 atomic %. In some other examples, the oxygen content is 9 atomic %. In some examples, the oxygen content is 10 atomic %.

As used herein, the term “LBHI” refers to a lithium conducting electrolyte including Li, B, H, and I. LBHI includes a compound having the formula aLiBH₄+bLiX where X═Cl, Br, and/or I and where a:b=7:1, 6:1, 5:1, 4:1, 3:1, 2:1, or within the range a/b=2-4. LBHI may further include nitrogen in the form of compound having the formula aLiBH₄+bLiX+cLiNH₂ where (a+c)/b=2-4 and c/a=0-10.

As used herein, the term “LPSI” refers to a lithium conducting electrolyte including Li, P, S, and I. LPSI includes a compound having the formula aLi₂S+bP₂S_{y}+cLiX where X═Cl, Br, and/or I and where y=3-5 and where a/b=2.5-4.5 and where (a+b)/c=0.5-15. LPSI may also contain up to 10% oxygen.

As used here, the phrase “composite electrolyte,” refers to an electrolyte, as referenced above, having at least two components, e.g., an inorganic solid-state electrolyte and a polymer bonded to the electrolyte, adhered to the electrolyte, or uniformly mixed with the electrolyte. In certain examples, the at least two components include a polymer, or organic binder, and an inorganic solid-state electrolyte. A composite electrolyte may include an inorganic solid-state electrolyte and a polymer, bonded thereto, adhered thereto, adsorbed there onto, or mixed therewith. A composite electrolyte may include an inorganic solid-state electrolyte and a polymer, bonded thereto, adhered thereto, adsorbed there onto, or mixed therewith. A composite electrolyte may include an inorganic solid-state electrolyte and the chemical precursors to a polymer which bonds to, adheres to, adsorbs onto, or mix with and/or entangles with, once polymerized, the inorganic solid-state electrolyte. A composite electrolyte may include an inorganic solid-state electrolyte and monomers which can be polymerized to form a polymer which bonds to, adheres to, adsorbs onto, or mix with and/or entangles with, once polymerized, the inorganic solid-state electrolyte. For example, a composite electrolyte may include a solid-state electrolyte, e.g., a sulfide-including electrolyte, and epoxide monomers or epoxide-including polymers. In such an example, the epoxide monomers can be polymerized by polymerization techniques known in the art, such as but not limited light-initiated or chemical-initiated, polymerization. Example composite electrolytes include, but are not limited to, those composite electrolytes set forth in U.S. patent application Ser. No. 15/192,960, filed Jun. 24, 2016, the entire contents of which are herein incorporated by reference in their entirety for all purposes.

As used herein, voltage is set forth with respect to lithium (i.e., V vs. Li) metal unless stated otherwise.

As used herein, the term “lithium titanium aluminum phosphate,” refers to a material characterized by the formula Li₁₊ₓAlₓ(Ti_{y})₂₋ₓ(PO₄)₃, wherein x is a rational number from 0 to 2 and y is a rational number from 0 to 1.

As used herein, the phrase “geometric surface area of the positive electrode layer and the geometric surface area solid-state separator layer are substantially the same,” means that the two referenced surface areas do not differ by more than 10% with respect to their absolute value.

As used herein, the terms “separator,” and “Li⁺ ion-conducting separator,” are used interchangeably with separator being a short-hand reference for Li⁺ ion-conducting separator, unless specified otherwise explicitly. A separator refers to a solid electrolyte which conducts Li⁺ ions, is substantially insulating to electrons, and which is suitable for use as a physical barrier or spacer between the positive and negative electrodes in an electrochemical cell or a rechargeable battery. A separator, as used herein, is substantially insulating when the separator's lithium ion conductivity is at least 10³, and typically 10⁶ times, greater than the separator's electron conductivity. A separator can be a film, monolith, or pellet. Unless explicitly specified to the contrary, a separator as used herein is stable when in contact with lithium metal.

As used herein, the phrase “solid-state cathode” or “solid-state positive electrode” refers to a type of “positive electrode” defined herein. In certain examples, all components in this solid-state cathode film are in solid form. The solid-state cathode includes active cathode materials as defined herein, solid-state catholyte as defined herein, optionally a conductive additive, and optionally binders. The solid-state cathode are in some examples densified films.

As used here, the phrase “solid-state electrolyte,” is used interchangeably with the phrase “solid separator” refers to a material which does not include carbon and which conducts atomic ions (e.g., Li⁺) but does not conduct electrons. An inorganic solid-state electrolyte is a solid material suitable for electrically isolating the positive and negative electrodes of a lithium secondary battery while also providing a conduction pathway for lithium ions. Example inorganic solid-state electrolytes include oxide electrolytes and sulfide electrolytes, which are further defined below. Non-limiting example sulfide electrolytes are found, for example, in U.S. Pat. No. 9,172,114, which issued Oct. 27, 2015, and also in US Patent Application Publication No. 2017-0162901 A1, which published Jun. 8, 2017, and was filed as U.S. patent application Ser. No. 15/367,103 on Dec. 1, 2016, the entire contents of which are herein incorporated by reference in its entirety for all purposes. Non-limiting example oxide electrolytes are found, for example, in US Patent Application Publication No. 2015-0200420 A1, which published Jul. 16, 2015, the entire contents of which are herein incorporated by reference in its entirety for all purposes. In some examples, the inorganic solid-state electrolyte also includes a polymer.

As used herein, the term “oxide” refers to a chemical compound that includes at least one oxygen atom and one other element in the chemical formula for the chemical compound. For example, an “oxide” is interchangeable with “oxide electrolytes.” Non-limiting examples of oxide electrolytes are found, for example, in US Patent Application Publication No. 2015/0200420, published Jul. 16, 2015, the entire contents of which are incorporated herein by reference in their entirety.

As used herein, the term “sulfide” refers to refers to a chemical compound that includes at least one sulfur atom and one other element in the chemical formula for the chemical compound. For example, a “sulfide” is interchangeable with “sulfide electrolytes.” Non-limiting examples of sulfide electrolytes are found, for example, in U.S. Pat. No. 9,172,114, issued Oct. 27, 2015, and also in US Patent Application Publication No. 2017-0162901 A1, which published Jun. 8, 2017, and was filed as U.S. patent application Ser. No. 15/367,103 on Dec. 1, 2016, the entire contents of which are herein incorporated by reference in its entirety for all purposes. As used herein, a sulfide catholyte is a catholyte that comprises or consists essentially of a sulfide.

As used herein, the term “sulfide-halide” refers to a chemical compound that includes at least one sulfur atom, at least one halogen atom, and one other element in the chemical formula for the chemical compound.

As used herein, voltage is set forth with respect to lithium (i.e., V vs. Li) metal unless stated otherwise.

Processes For Compressing Layered Stacks

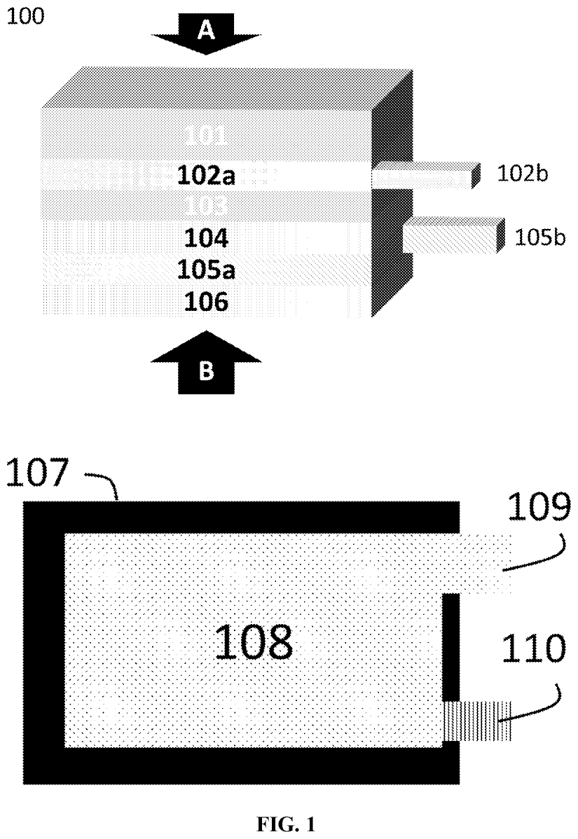

An example process, 100A, is shown in FIG. 1. In FIG. 1, a positive electrode current collector, 102a, is provided. The positive electrode current collector, 102a, includes tab, 102b. A first trilayer stack is made by laminating a first positive electrode layer, 101, and second positive electrode layer, 103, to opposite surfaces of the positive electrode current collector, 102a. Once both the first positive electrode layer, 101, and the second positive electrode layer, 103, are laminated to surfaces of the positive electrode current collector, 102a, as shown in FIG. 1, then a positive electrode trilayer is made. The trilayer includes three layers—one layer is positive electrode layer, 101; one layer is positive electrode layer, 103; and one layer is the current collector layer, 102a. A second trilayer stack is made by laminating a first separator, 104, or second separator, 106, to opposite surfaces of the negative electrode current collector, 105a. The negative electrode current collector, 105a, includes tab, 105b. Once both a separator, 104, and separator, 106, are laminated to surfaces of the negative electrode current collector, 105a, as shown in FIG. 1, then a separator trilayer is made. The positive electrode trilayer and the separator trilayer are then be compressed. Arrows A and B in FIG. 1 indicate that the compression is done by uniaxial pressure, which may optionally be isostatic. In some examples, the process operates in a hybrid process which includes applying both uniaxial and isostatic pressure. In some examples, between separator, 104, and the negative electrode current collector, 105a, is lithium metal.

As shown in FIG. 1, when the compressing step occurs, the layered stacks are placed in a pressing die, 107. The current collector is shown as 108 and has tab, 109, extending beyond the edge of the current collector. The die, 107, has cutout areas to accommodate the positioning of the tab, 109, during the compressing step. Not shown is a second current collector that has tab, 110. Tab 110 is shown. The die, 107, has cutout areas to accommodate the positioning of the tab, 110, during the compressing step.

In some examples, process 100A can be performed but without positive electrode layer, 101, or separator layer, 106. In this example, a positive electrode current collector, 102a, is provided. The positive electrode current collector, 102a, includes tab, 102b. A first bilayer stack is made by laminating positive electrode layer, 103, to a surface of the positive electrode current collector, 102a. The resulting bilayer includes two layers—one layer is positive electrode layer, 103; and one layer is the current collector layer, 102a. A second bilayer stack is made by laminating a separator, 104, to a surface of the negative electrode current collector, 105a. The negative electrode current collector, 105a, includes tab, 105b. The resulting bilayer includes two layers—one layer is negative electrode current collector, 105a; and one layer is the separator, 104. The positive electrode bilayer and the separator bilayer are then be compressed. Arrows A and B in FIG. 1 indicate that the compression is done by uniaxial pressure, which may optionally be isostatic.

In some examples, set forth herein is a process for making a solid-state battery including (a) providing at least three layered stacks; and (b) compressing the layered stacks at a pressure in the range of 30 MPA to 5000 MPa and at a temperature of 15° C. to 250° C. In some examples, set forth herein is a process for making a solid-state battery including (a) providing at least four layered stacks; and (b) compressing the layered stacks at a pressure in the range of 30 MPA to 5000 MPa and at a temperature of 15° C. to 250° C. In some examples, set forth herein is a process for making a solid-state battery including (a) providing at least five layered stacks; and (b) compressing the layered stacks at a pressure in the range of 30 MPA to 5000 MPa and at a temperature of 15° C. to 250° C. In some examples, set forth herein is a process for making a solid-state battery including (a) providing at least six layered stacks; and (b) compressing the layered stacks at a pressure in the range of 30 MPA to 5000 MPa and at a temperature of 15° C. to 250° C. In some examples, set forth herein is a process for making a solid-state battery including (a) providing at least seven layered stacks; and (b) compressing the at least seven layered stacks at a pressure in the range of 30 MPA to 5000 MPa and at a temperature of 15° C. to 250° C. In some examples, set forth herein is a process for making a solid-state battery including (a) providing at least eight layered stacks; and (b) compressing the at least eight layered stacks at a pressure in the range of 30 MPA to 5000 MPa and at a temperature of 15° C. to 250° C. In some examples, set forth herein is a process for making a solid-state battery including (a) providing at least nine layered stacks; and (b) compressing the at least nine layered stacks at a pressure in the range of 30 MPA to 5000 MPa and at a temperature of 15° C. to 250° C. In some examples, set forth herein is a process for making a solid-state battery including (a) providing at least ten layered stacks; and (b) compressing the at least ten layered stacks at a pressure in the range of 30 MPA to 5000 MPa and at a temperature of 15° C. to 250° C. In some examples, set forth herein is a process for making a solid-state battery including (a) providing at least twenty layered stacks; and (b) compressing the at least twenty layered stacks at a pressure in the range of 30 MPA to 5000 MPa and at a temperature of 15° C. to 250° C. In some examples, set forth herein is a process for making a solid-state battery including (a) providing at least thirty layered stacks; and (b) compressing the layered stacks at a pressure in the range of 30 MPA to 5000 MPa and at a temperature of 15° C. to 250° C. In some examples, set forth herein is a process for making a solid-state battery including (a) providing at least forty layered stacks; and (b) compressing the layered stacks at a pressure in the range of 30 MPA to 5000 MPa and at a temperature of 15° C. to 250° C. In some examples, set forth herein is a process for making a solid-state battery including (a) providing at least fifty layered stacks; and (b) compressing the layered stacks at a pressure in the range of 30 MPA to 5000 MPa and at a temperature of 15° C. to 250° C. In some examples, set forth herein is a process for making a solid-state battery including (a) providing at least sixty layered stacks; and (b) compressing the layered stacks at a pressure in the range of 30 MPA to 5000 MPa and at a temperature of 15° C. to 250° C. In some examples, set forth herein is a process for making a solid-state battery including (a) providing at least seventy layered stacks; and (b) compressing the layered stacks at a pressure in the range of 30 MPA to 5000 MPa and at a temperature of 15° C. to 250° C. In some examples, set forth herein is a process for making a solid-state battery including (a) providing at least eighty layered stacks; and (b) compressing the layered stacks at a pressure in the range of 30 MPA to 5000 MPa and at a temperature of 15° C. to 250° C. In some examples, set forth herein is a process for making a solid-state battery including (a) providing at least ninety layered stacks; and (b) compressing the layered stacks at a pressure in the range of 30 MPA to 5000 MPa and at a temperature of 15° C. to 250° C. In some examples, set forth herein is a process for making a solid-state battery including (a) providing at least one hundred layered stacks; and (b) compressing the layered stacks at a pressure in the range of 30 MPA to 5000 MPa and at a temperature of 15° C. to 250° C.

In some examples, set forth herein is a process for making a solid-state battery including (a) providing at least three layered stacks; and (b) compressing the layered stacks at a pressure in the range of 0.0001 kPa to 1000 kPa and at a temperature of 15° C. to 250° C. In some examples, set forth herein is a process for making a solid-state battery including (a) providing at least four layered stacks; and (b) compressing the layered stacks at a pressure in the range of 0.0001 kPa to 1000 kPa and at a temperature of 15° C. to 250° C. In some examples, set forth herein is a process for making a solid-state battery including (a) providing at least five layered stacks; and (b) compressing the layered stacks at a pressure in the range of 0.0001 kPa to 1000 kPa and at a temperature of 15° C. to 250° C. In some examples, set forth herein is a process for making a solid-state battery including (a) providing at least six layered stacks; and (b) compressing the layered stacks at a pressure in the range of 0.0001 kPa to 1000 kPa and at a temperature of 15° C. to 250° C. In some examples, set forth herein is a process for making a solid-state battery including (a) providing at least seven layered stacks; and (b) compressing the at least seven layered stacks at a pressure in the range of 0.0001 kPa to 1000 kPa and at a temperature of 15° C. to 250° C. In some examples, set forth herein is a process for making a solid-state battery including (a) providing at least eight layered stacks; and (b) compressing the at least eight layered stacks at a pressure in the range of 0.0001 kPa to 1000 kPa and at a temperature of 15° C. to 250° C. In some examples, set forth herein is a process for making a solid-state battery including (a) providing at least nine layered stacks; and (b) compressing the at least nine layered stacks at a pressure in the range of 0.0001 kPa to 1000 kPa and at a temperature of 15° C. to 250° C. In some examples, set forth herein is a process for making a solid-state battery including (a) providing at least ten layered stacks; and (b) compressing the at least ten layered stacks at a pressure in the range of 0.0001 kPa to 1000 kPa and at a temperature of 15° C. to 250° C. In some examples, set forth herein is a process for making a solid-state battery including (a) providing at least twenty layered stacks; and (b) compressing the at least twenty layered stacks at a pressure in the range of 0.0001 kPa to 1000 kPa and at a temperature of 15° C. to 250° C. In some examples, set forth herein is a process for making a solid-state battery including (a) providing at least thirty layered stacks; and (b) compressing the layered stacks at a pressure in the range of 0.0001 kPa to 1000 kPa and at a temperature of 15° C. to 250° C. In some examples, set forth herein is a process for making a solid-state battery including (a) providing at least forty layered stacks; and (b) compressing the layered stacks at a pressure in the range of 0.0001 kPa to 1000 kPa and at a temperature of 15° C. to 250° C. In some examples, set forth herein is a process for making a solid-state battery including (a) providing at least fifty layered stacks; and (b) compressing the layered stacks at a pressure in the range of 0.0001 kPa to 1000 kPa and at a temperature of 15° C. to 250° C. In some examples, set forth herein is a process for making a solid-state battery including (a) providing at least sixty layered stacks; and (b) compressing the layered stacks at a pressure in the range of 0.0001 kPa to 1000 kPa and at a temperature of 15° C. to 250° C. In some examples, set forth herein is a process for making a solid-state battery including (a) providing at least seventy layered stacks; and (b) compressing the layered stacks at a pressure in the range of 0.0001 kPa to 1000 kPa and at a temperature of 15° C. to 250° C. In some examples, set forth herein is a process for making a solid-state battery including (a) providing at least eighty layered stacks; and (b) compressing the layered stacks at a pressure in the range of 0.0001 kPa to 1000 kPa and at a temperature of 15° C. to 250° C. In some examples, set forth herein is a process for making a solid-state battery including (a) providing at least ninety layered stacks; and (b) compressing the layered stacks at a pressure in the range of 0.0001 kPa to 1000 kPa and at a temperature of 15° C. to 250° C. In some examples, set forth herein is a process for making a solid-state battery including (a) providing at least one hundred layered stacks; and (b) compressing the layered stacks at a pressure in the range of 0.0001 kPa to 1000 kPa and at a temperature of 15° C. to 250° C.

In some examples, set forth herein is a process for making a solid-state battery including (a) providing at least two layered stacks; and (b) compressing the at least two layered stacks at a pressure in the range of 0.0001 kPa to 1000 kPa and at a temperature of 15° C. to 250° C. In some examples, each layered stack, individually in each instance, includes a current collector layer having exposed tabs and at least one member selected from the group consisting of a positive electrode layer and a solid-state separator layer. In some examples, the temperature is selected from the group consisting of 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., 131° C., 132° C., 133° C., 134° C., 135° C., 136° C., 137° C., 138° C., 139° C., 140° C., 141° C., 142° C., 143° C., 144° C., 145° C., 146° C., 147° C., 148° C., 149° C., 150° C., 151° C., 152° C., 153° C., 154° C., 155° C., 156° C., 157° C., 158° C., 159° C., 160° C., 161° C., 162° C., 163° C., 164° C., 165° C., 166° C., 167° C., 168° C., 169° C., 170° C., 171° C., 172° C., 173° C., 174° C., 175° C., 176° C., 177° C., 178° C., 179° C., 180° C., 181° C., 182° C., 183° C., 184° C., 185° C., 186° C., 187° C., 188° C., 189° C., 190° C., 191° C., 192° C., 193° C., 194° C., 195° C., 196° C., 197° C., 198° C., 199° C., 200° C., 201° C., 202° C., 203° C., 204° C., 205° C., 206° C., 207° C., 208° C., 209° C., 210° C., 221° C., 212° C., 213° C., 214° C., 215° C., 216° C., 217° C., 218° C., 219° C., 220° C., 221° C., 222° C., 223° C., 224° C., 225° C., 226° C., 227° C., 228° C., 229° C., 230° C., 231° C., 232° C., 233° C., 234° C., 235° C., 236° C., 237° C., 238° C., 239° C., 240° C., 241° C., 242° C., 243° C., 244° C., 245° C., 246° C., 247° C., 248° C., 249° C., and 250° C. In some examples, the temperature is between about 10° C. to about 100° C. In some examples, the temperature is between about 10° C. to about 200° C. In some examples, the temperature is between about 10° C. to about 250° C. In some examples, the temperature is between about 50° C. to about 100° C. In some examples, the temperature is between about 50° C. to about 200° C. In some examples, the temperature is between about 50° C. to about 250° C. In some examples, the temperature is between about 75° C. to about 100° C. In some examples, the temperature is between about 75° C. to about 200° C. In some examples, the temperature is between about 75° C. to about 250° C. In some examples, the pressure is selected from the group consisting of 0.0001, 0.001, 0.01, 0.1, 1, 2, 3, 4, 5, 6, 7, 8, 9, 10, 20, 30, 40, 50, 60, 70, 80, 90, 100, 110, 120, 130, 140, 150, 160, 170, 180, 190, 200, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 660, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, and 1000 kPSI (kilo-pounds-per-square inch, i.e., 1000-pounds-per-square-inch). In some examples, the pressure is between about 10 to about 100 kPSI. In some examples, the pressure is between about 100 to about 200 kPSI. In some examples, the pressure is between about 200 to about 300 kPSI. In some examples, the pressure is between about 300 to about 400 kPSI. In some examples, the pressure is between about 400 to about 500 kPSI. In some examples, the pressure is between about 500 to about 600 kPSI. In some examples, the pressure is between about 600 to about 700 kPSI. In some examples, the pressure is between about 700 to about 800 kPSI. In some examples, the pressure is between about 800 to about 900 kPSI. In some examples, the pressure is between about 900 to about 1000 kPSI. In some examples, the pressure is between about 150 to about 250 kPSI. In some examples, the pressure is between about 250 to about 350 kPSI. In some examples, the pressure is between about 350 to about 450 kPSI. In some examples, the pressure is between about 450 to about 550 kPSI. In some examples, the pressure is between about 550 to about 650 kPSI. In some examples, the pressure is between about 650 to about 750 kPSI. In some examples, the pressure is between about 750 to about 850 kPSI. In some examples, the pressure is between about 850 to about 950 kPSI. In some examples, the pressure is between about 950 to about 1000 kPSI.

In some examples, including any of the foregoing, the process includes compressing the at least two layered stacks at a pressure less than 85 kPSI.

In some examples, including any of the foregoing, the process includes compressing the at least two layered stacks at a pressure of about 7 kPSI to 725 kPSI.

In some examples, including any of the foregoing, the process includes compressing the at least two layered stacks at a pressure in the range of 0 kPSI to 100 kPSI.

In some examples, including any of the foregoing, the process includes compressing the at least two layered stacks at a pressure of about 25 kPSI.

In some examples, including any of the foregoing, the process includes compressing the at least two layered stacks at a pressure of about 35 kPSI.

In some examples, including any of the foregoing, the process includes compressing the at least two layered stacks at a pressure of about 45 kPSI.

In some examples, including any of the foregoing, the process includes compressing the at least two layered stacks at a pressure of about 55 kPSI.

In some examples, including any of the foregoing, the process includes compressing the at least two layered stacks at a pressure of about 65 kPSI.

In some examples, including any of the foregoing, the process includes compressing the at least two layered stacks at a pressure of about 75 kPSI.

In some examples, including any of the foregoing, the process includes compressing the at least two layered stacks at a pressure of about 85 kPSI.

In some examples, including any of the foregoing, the process includes compressing the at least two layered stacks at a pressure of about 95 kPSI.

In some examples, including any of the foregoing, the process includes compressing the at least two layered stacks at a pressure of about 105 kPSI.

In some examples, including any of the foregoing, the process includes compressing the at least two layered stacks at a pressure of about 115 kPSI.

In some examples, including any of the foregoing, the process includes compressing the at least two layered stacks at a pressure of about 125 kPSI.

In some examples, including any of the foregoing, the process includes compressing the at least two layered stacks at a pressure of about 135 kPSI.

In some examples, including any of the foregoing, the process includes compressing the at least two layered stacks at a pressure of about 145 kPSI.

In some examples, including any of the foregoing, the process includes compressing the at least two layered stacks at a pressure of about 155 kPSI.

In some examples, including any of the foregoing, the process includes compressing the at least two layered stacks at a temperature between about 100° C. and 180° C.

In some examples, including any of the foregoing, the process includes compressing the at least two layered stacks at a temperature less than 170° C.

In some examples, including any of the foregoing, the providing step includes assembling a layered stack.

In some examples, including any of the foregoing, the process includes compressing a surface of a positive electrode layer of one of the at least two layered stacks against a surface of a solid-state separator layer of one of the at least two layered stacks. In some of these examples, a bilayer of a positive electrode layer and a first current collector is compressed against a bilayer of a solid-state separator layer and a second current collector layer. In some other of these examples, a trilayer including two positive electrode layers and a first current collector is compressed against a trilayer including two solid-state separator layers and a second current collector layer. An example of two trilayers compressing according to this process is illustrated in FIG. 1.

In some examples, including any of the foregoing, the process includes calendering at least one of the at least two layered stacks prior to the compressing step.

In some examples, including any of the foregoing, at least one layered stack includes a current collector layer and a positive electrode layer, wherein the current collector layer is in electrical contact with the positive electrode layer.

In some examples, including any of the foregoing, the current collector layer is a positive electrode current collector layer.

In some examples, including any of the foregoing, at least one layered stack includes a current collector and a solid-state separator layer, wherein the solid-state separator layer is in electrical contact with the current collector.

In some examples, including any of the foregoing, one of the at least one layered stack includes a negative electrode layer.

In some examples, including any of the foregoing, the negative electrode layer is a lithium (Li) metal electrode layer.

In some examples, including any of the foregoing, the positive electrode layer includes a sulfide single ion conductor and an active material.

In some examples, including any of the foregoing, the solid-state separator layer includes a sulfide single ion conductor.

In some examples, including any of the foregoing, the solid-state separator layer includes LPSI.

In some examples, including any of the foregoing, a current collector layer is made of a material selected from the group consisting of carbon (C)-coated nickel (Ni), C-coated aluminum (Al), nickel (Ni), copper (Cu), aluminum (Al), stainless steel, Palladium (Pd), and Platinum (Pt). In some examples, the current collector layer is C-coated Ni. In some examples, the current collector layer is C-coated Al.

In some examples, including any of the foregoing, a current collector layer is a negative electrode current collector layer, wherein the negative electrode current collector layer is made of a material selected from the group consisting of carbon (C)-coated nickel (Ni), nickel (Ni), and copper (Cu). In some examples, the current collector layer is C-coated Ni. In some examples, the current collector layer is C-coated Al.

In some examples, including any of the foregoing, the current collector layer is a metal that has another metal deposited on it or alloyed with it. For example, a negative current collector layer may include a metal such as Ni or Al. The metal—Ni or Al—may have islands deposited thereupon wherein the islands are another metal. In some examples, the another metal is a metal which forms an alloy with lithium (Li). In some examples, the another metal is indium (In). In some examples, the another metal is bismuth (Bi). In some examples, the another metal is silver (Ag).

In some examples, the another metal is zinc (Zn). In some examples, the current collector layer may be coated with carbon.

In some examples, including any of the foregoing, a current collector layer is a positive electrode current collector layer, wherein the positive electrode current collector layer is made of a material selected from the group consisting of carbon (C)-coated aluminum.

In some examples, including any of the foregoing, the negative electrode current collector layer is C-coated Ni.

In some examples, including any of the foregoing, the solid-state separator layer is rectangular shaped.

In some examples, including any of the foregoing, the positive electrode layer is rectangular shaped.

In some examples, including any of the foregoing, the solid-state separator layer is circular shaped.

In some examples, including any of the foregoing, the positive electrode layer is circular shaped.

In some examples, including any of the foregoing, the geometric surface area of the positive electrode layer and the geometric surface area solid-state separator layer are substantially the same. In some examples, the solid-state separator has less than 1 mm overhang compared to the positive and/or negative electrode. In some examples, the solid-state separator has less than 0.5 mm overhang compared to the positive and/or negative electrode. In some examples, the solid-state separator has less than 0.2 mm overhang compared to the positive and/or negative electrode. Overhang herein refers to the extent to which one layer, e.g., positive electrode layer, extends beyond the edge of another layer, e.g., solid-state separator layer, when the two layers are stacked one on top of the other. In some examples, the geometric surface area of the positive electrode layer and the geometric surface area solid-state separator layer do not differ by more than 10% in absolute value. In some examples, the geometric surface area of the positive electrode layer and the geometric surface area solid-state separator layer do not differ by more than 9% in absolute value. In some examples, the geometric surface area of the positive electrode layer and the geometric surface area solid-state separator layer do not differ by more than 8% in absolute value. In some examples, the geometric surface area of the positive electrode layer and the geometric surface area solid-state separator layer do not differ by more than 7% in absolute value. In some examples, the geometric surface area of the positive electrode layer and the geometric surface area solid-state separator layer do not differ by more than 6% in absolute value. In some examples, the geometric surface area of the positive electrode layer and the geometric surface area solid-state separator layer do not differ by more than 5% in absolute value. In some examples, the geometric surface area of the positive electrode layer and the geometric surface area solid-state separator layer do not differ by more than 4% in absolute value. In some examples, the geometric surface area of the positive electrode layer and the geometric surface area solid-state separator layer do not differ by more than 3% in absolute value. In some examples, the geometric surface area of the positive electrode layer and the geometric surface area solid-state separator layer do not differ by more than 2% in absolute value. In some examples, the geometric surface area of the positive electrode layer and the geometric surface area solid-state separator layer do not differ by more than 1% in absolute value. In some examples, the geometric surface area of the positive electrode layer and the geometric surface area solid-state separator layer do not differ by more than 0.1% in absolute value. In some examples, the geometric surface area of the positive electrode layer and the geometric surface area solid-state separator layer do not differ by more than 0.01% in absolute value. In some examples, the geometric surface area of the positive electrode layer and the geometric surface area solid-state separator layer do not differ by more than 0.001% in absolute value. In some examples, the geometric surface area of the positive electrode layer and the geometric surface area solid-state separator layer do not differ by more than 0.0001% in absolute value.

In some examples, including any of the foregoing, one edge of the positive electrode layer is 10 cm in length.

In some examples, including any of the foregoing, one edge of the solid-state separator layer is about 10 cm in length.

In some examples, including any of the foregoing, the positive electrode layer has a diameter that is about 10 cm in length.

In some examples, including any of the foregoing, one edge of the solid-state separator layer is 10 cm in length.

In some examples, including any of the foregoing, the positive electrode layer has a diameter that is 10 cm in length.

In some examples, including any of the foregoing, the solid-state separator layer has a diameter that is 10 cm in length.

In some examples, including any of the foregoing, the solid-state separator layer is a sulfide electrolyte.

In some examples, including any of the foregoing, the sulfide electrolyte includes lithium (Li), phosphorus (P), and sulfur (S).

In some examples, including any of the foregoing, the sulfide electrolyte further includes iodine (I).

In some examples, including any of the foregoing, the sulfide electrolyte further includes a member selected from the group consisting of Tin (Sn), germanium (Ge), arsenic (As), silicon (Si), chlorine (Cl), bromine (Br), and a combination thereof.

In some examples, including any of the foregoing, the sulfide electrolyte is LSTPS.

In some examples, including any of the foregoing, the sulfide electrolyte is LPSI.

In some examples, including any of the foregoing, the positive electrode layer includes a catholyte.

In some examples, including any of the foregoing, the positive electrode layer comprises a percolating network of fast ion conductor material.

In some examples, including any of the foregoing, the solid-state separator layer comprises a percolating network of fast ion conductor material.

In some examples, including any of the foregoing, the positive electrode layer includes an active material at a mass loading of about 75—about 90% by mass.

In some examples, including any of the foregoing, the active material includes a lithium intercalation material, a lithium conversion material, or both a lithium intercalation material and a lithium conversion material.

In some examples, including any of the foregoing, the intercalation material is selected from the group consisting of a nickel manganese cobalt oxide (NMC), a nickel cobalt aluminum oxide (NCA), Li(NiCoAl)O₂, a lithium cobalt oxide (LCO), a lithium manganese cobalt oxide (LMCO), a lithium nickel manganese cobalt oxide (LMNCO), a lithium nickel manganese oxide (LNMO), Li(NiCoMn)O₂, LiMn₂O₄, LiCoO₂, and LiMn2-ₐNiₐO₄, wherein a is from 0 to 2, or LiMPO₄, wherein M is Fe, Ni, Co, or Mn.

In some examples, including any of the foregoing, the lithium conversion material is selected from the group consisting of FeF₂, NiF₂, FeOₓF₃₋₂ₓ, FeF₃, MnF₃, CoF₃, CuF₂ materials, alloys thereof, and combinations thereof.

In some examples, including any of the foregoing, the active material is NCA.

In some examples, including any of the foregoing, the active material is NMC.

In some examples, including any of the foregoing, the positive electrode layer includes a catholyte. In some examples, the catholyte is selected from LPSI, LSTPS, and LBHI. In some examples, the catholyte is LPSI. In some examples, the catholyte is LSTPS. In some examples, the catholyte is LBHI.

In some examples, including any of the foregoing, the positive electrode layer includes a catholyte at a mass loading of about 10—about 25%. In some examples, the catholyte is LSTPS or LSPSCl. In some examples, including any of the foregoing, the catholyte is LSTPS. In some examples, including any of the foregoing, the catholyte is LSPSCl.

In some examples, including any of the foregoing, the positive electrode layer includes a carbon at a mass loading of about 0 to about 1%. In some examples, the carbon is C65 or VGCF.

In some examples, including any of the foregoing, the positive electrode layer includes a binder at a mass loading of about 0 to about 2.5%.

In some examples, the binder is a polymer or copolymer. In some examples, the polymeric binder is an alpha-olefin, wherein the double bond of the alkene is in the primary position. In some examples, the binder is an ethylene alpha-olefin copolymer. In some examples, including any of the foregoing, the binder includes POB3 (commercial name: Affinity 8200G). In some examples, the binder is polyethylene oxide.

In some examples, the binder may include PVDF, PVDF-HFP, and SBR.

In some examples, including any of the foregoing, the thickness of the positive electrode layer is from about 10 μm to about 500 μm. In some examples, the thickness of the positive electrode layer is selected from the group consisting of about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, and 500 μm. In some examples, including any of the foregoing, the thickness of the positive electrode layer is from 100 μm to about 500 μm. In some examples, including any of the foregoing, the thickness of the solid-state separator layer is from about 1 μm to about 200 μm. In some examples, including any of the foregoing, the thickness of the positive electrode current collector layer is from about 10 μm to about 200 μm. In some examples, including any of the foregoing, the thickness of the positive electrode current collector layer is about 15 μm.

In some examples, including any of the foregoing, the thickness of the negative electrode current collector layer is from 6 μm to about 100 μm. In some examples, the thickness of the negative electrode current collector layer is selected from the group consisting of about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, and about 100 μm.

In some examples, including any of the foregoing, the thickness of the positive electrode current collector layer is about 15 μm. In some examples, the thickness of the positive electrode current collector layer is selected from the group consisting of about 1 μm, about 2 μm, about 3 μm, about 4 μm, about 5 μm, about 6 μm, about 7 μm, about 8 μm, about 9 μm, about 10 μm, about 11 about about 12 μm, about 13 μm, about 14 μm, and about 15 μm.

In some examples, including any of the foregoing, the thickness of the positive electrode current collector layer is about 15 μm. In some examples, the thickness of the positive electrode current collector layer is selected from the group consisting of 1 μm, 2 μm, 3 μm, 4 μm, 5 μm, 6 μm, 7 μm, 8 μm, 9 μm, 10 μm, 11 μm, 12 μm, 13 μm, 14 μm, and 15 μm.

In some examples, including any of the foregoing, the thickness of the tabs on the current collector layer is from about 5 μm to about 100 μm

In some examples, including any of the foregoing, the solid-state separator is made by a process which includes milling a solid-state separator material and casting the milled solid-state separator material as a thin layer.

In some examples, including any of the foregoing, the compressing step occurs in a die.

In some examples, including any of the foregoing, the compressing step is uniaxial.

In some examples, including any of the foregoing, the compressing step is isostatic.

In some examples, including any of the foregoing, the die includes cut-outs for the exposed tabs.

In some examples, including any of the foregoing, two of the at least two electrochemical stacks share either a positive current collector layer or a negative current collector layer.

Solid-State Separator Layers and Processes For Making Solid-State Separator Layers

In the methods and processes set forth herein, a variety of sulfide electrolytes may be suitable for use.

In some examples, the separator is a polymer-sulfide composite. Example composite electrolytes include, but are not limited to, those composite electrolytes set forth in US Patent Application Publication No. US20170005367, filed as U.S. patent application Ser. No. 15/192,960, on Jun. 24, 2016, the entire contents of which are herein incorporated by reference in their entirety for all purposes.

In some examples the sulfide electrolyte is selected from any sulfur or sulfide including electrolyte set forth in U.S. Pat. Nos. 9,172,114; 9,634,354; 9,553,332; and 9,819,024, the entire contents of each of which are herein incorporated by reference in their entirety for all purposes.

In some examples the downsizing method is selected from any downsizing method set forth in U.S. Pat. Nos. 9,172,114; 9,634,354; 9,553,332; and 9,819,024, the entire contents of each of which are herein incorporated by reference in their entirety for all purposes.

In some examples the sulfide electrolyte is selected from any sulfur or sulfide including electrolyte set forth in International Patent Application Publication No. WO2017096088 A1, entitled LITHIUM, PHOSPHORUS, SULFUR, AND IODINE CONTAINING ELECTROLYTE AND CATHOLYTE COMPOSITIONS, ELECTROLYTE MEMBRANES FOR ELECTROCHEMICAL DEVICES, AND ANNEALING METHODS OF MAKING THESE ELECTROLYTES AND CATHOLYTES, filed as PCT/US2016/064492 on Dec. 1, 2016, the entire contents of which are herein incorporated by reference in their entirety for all purposes.

In some examples the sulfide electrolyte is selected from any sulfur or sulfide including electrolyte set forth in US Patent Application Publication No. US20150171465, entitled SOLID STATE CATHOLYTE OR ELECTROLYTE FOR BATTERY USING LiaMPbSc (M═Si, Ge, and/or Sn), filed as U.S. patent application Ser. No. 14/618,979, on Feb. 10, 2015, the entire contents of which are herein incorporated by reference in their entirety for all purposes.

In some examples the sulfide catholyte is selected from any sulfur or sulfide including electrolyte set forth in US Patent Application Publication No. US20150171465, entitled SOLID STATE CATHOLYTE OR ELECTROLYTE FOR BATTERY USING LiaMPbSc (M═Si, Ge, and/or Sn), filed as U.S. patent application Ser. No. 14/618,979, on Feb. 10, 2015, the entire contents of which are herein incorporated by reference in their entirety for all purposes.

In some examples the sulfide percolating network in any percolating network set forth in U.S. Pat. No. 9,859,560, entitled ELECTRODE MATERIALS WITH MIXED PARTICLE SIZES, which issued Jan. 2, 2018, the entire contents of which are herein incorporated by reference in their entirety for all purposes.

Positive Electrode Layers And Processes For Making Cathode Layers

In the methods and processes set forth herein, a variety of positive electrode materials may be suitable for use.

In some examples, the positive electrode includes an active material selected from any active material set forth in, US Patent Application Publication No. US20160211517, entitled LITHIUM RICH NICKEL MANGANESE COBALT OXIDE, filed as U.S. patent application Ser. No. 14/978,808, on Dec. 22, 2015, the entire contents of each of which are herein incorporated by reference in their entirety for all purposes.

In some examples, the positive electrode includes a binder.

In some examples, the positive electrode includes carbon as an electronic conductor.

In some examples the positive electrode percolating network in any percolating network set forth in U.S. Pat. No. 9,859,560, entitled ELECTRODE MATERIALS WITH MIXED PARTICLE SIZES, which issued Jan. 2, 2018, the entire contents of which are herein incorporated by reference in their entirety for all purposes.

In some examples the sulfide catholyte is selected from any sulfur or sulfide including electrolyte set forth in U.S. Pat. Nos. 9,172,114; 9,634,354; 9,553,332; and 9,819,024, the entire contents of each of which are herein incorporated by reference in their entirety for all purposes.

In some examples the sulfide catholyte is selected from any sulfur or sulfide including electrolyte set forth in International Patent Application Publication No. WO2017096088 A1, entitled LITHIUM, PHOSPHORUS, SULFUR, AND IODINE CONTAINING ELECTROLYTE AND CATHOLYTE COMPOSITIONS, ELECTROLYTE MEMBRANES FOR ELECTROCHEMICAL DEVICES, AND ANNEALING METHODS OF MAKING THESE ELECTROLYTES AND CATHOLYTES, filed as PCT/US2016/064492 on Dec. 1, 2016, the entire contents of which are herein incorporated by reference in their entirety for all purposes.

In some examples, the positive electrode includes carbon as an electronic conductor. In some examples, the carbon may include VGCF, carbon nanotubes, carbon fibers, carbon nanowires, C65, acetylene black, graphite, and the like. In some examples, the positive electrode comprises between 0-5 wt % carbon.

In some examples the positive electrode percolating network in any percolating network set forth in U.S. Pat. No. 9,859,560, entitled ELECTRODE MATERIALS WITH MIXED PARTICLE SIZES, which issued Jan. 2, 2018, the entire contents of which are herein incorporated by reference in their entirety for all purposes.

### EXAMPLES

Reagents, chemicals, and materials were commercially purchased unless specified otherwise to the contrary. Pouch cell containers were purchased from Showa Denko.

The Electrochemical potentiostat used was an Arbin potentiostat. Electrical impedance spectroscopy (EIS) was performed with a Biologic VMP3, VSP, VSP-300, SP-150, or SP-200.

Electron microscopy was performed in a FEI Quanta SEM, a Helios 600 i, or a Helios 660 FIB-SEM.

XRD was performed in a Bruker D8 Advance ECO or a Rigaku MiniFlex 2 with Cu K-α radiation, 6 mm slit width, at a scan time of 76 ms per step or 0.4 seconds per step, and at room temperature. Viscosity is measured using Rheometer under the shear rate of 100 s⁻¹.

Milling was performed using a Retsch PM 400 Planetary Ball Mill.

Mixing was performed using a Fischer Scientific vortex mixer, a Flaktek speed mixer, or a Primix filmix homogenizer.

Casting was performed on a TQC drawdown table.

Calendering was performed on an IMC calender.

Light scattering was performed on a Horiba, model: Partica, model no: LA-950V2, general term: laser scattering particle size distribution analyzer.

### Example 1

### Making an All Sulfide Cell

This example demonstrates how to make an all sulfide cell.

### Making an Electrolyte Bilayer Stack

Milling step: An LPSI composition (L_{7.4}P_{1.6}S_{7.2}I) was downsized by milling the composition until the particle size as determined by light scatting had a d₅₀<4 μm. 40 wt % LPSI in toluene was used for this milling step. This suspension was mixed with 3 steel media balls (¼′ dia) in a Flaktek mixer.

Casting step: A nickel (Ni) foil current collector was provided (Showa Denko). The suspension from the previous step was mixed with additional toluene and cast as a slurry onto the current collector substrate. The doctor-blade casting conditions included a casting speed of 100 mm/s. Blade height was set to 100 μm and 50 μm. The cast step was performed at 75° C.

The film was dried to form a solid-state electrolyte on the Ni foil current collector.

### Making A Positive Electrode Bilayer Stack

Positive Electrode Layer Formulation: Three types of positive electrode layers were made. One positive electrode layer included 66 vol % coated-NCA, 26 vol % LSTPS (In this example, the LSTPS composition was Li₁₀Si_{0.5}Sn_{0.5}P₂S₁₂) and 6 vol % binder (Dow Plastics Affinity EG 8200G). Another positive electrode layer included 72 vol % coated-NCA and 26 vol % LSTPS.

In this Example, coated-NCA refers to NCA coated with lithium zirconate or lithium niobate coating.

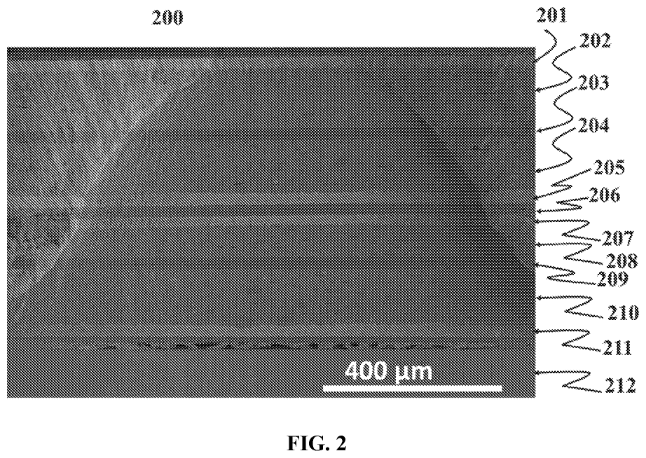

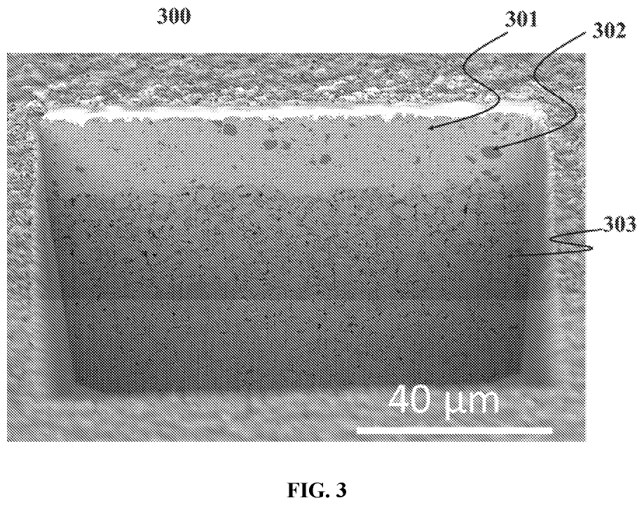

Another positive electrode layer was made and included 65 vol % coated-NCA, 28 vol % LSTPS, 6 vol % binder, and 1 vol % carbon (In this example, the LSTPS composition was Li₁₀Si_{0.5}Sn_{0.5}P₂S₁₂). This positive electrode layer in this paragraph was used in subsequent steps and imaged by scanning electron microscopy in FIG. 2-3.

The positive electrode compositions were formulated as a slurry and cast onto a current collector substrate. A carbon-coated Al current collector was provided as the current collector substrate (Showa Denko, SDX Carbon Coated Aluminum Foil). Solids were suspended in toluene, 54 wt % solids. Cast speed: 100 mm/s, cast temperature: 65° C., doctor blade height: 500 μm.

The positive electrode bilayer stack and the electrolyte bilayer stack were positioned so the positive electrode contacted the electrolyte. The resulting multilayer stack was pressed uniaxially at 150-220° C. and 207 to 586 MPa (mega-Pascal).

This process was repeated to build up the multilayer stack shown in FIG. 2.

In FIG. 2, several layers are shown. Layer 201 is an LPSI solid-state separator dense stack without tabs. Layer 202 is a positive electrode layer. Layer 203 is positive current collector (SDX Carbon Coated Aluminum Foil). Layer 204 is a positive electrode layer. Layer 205 is an LPSI solid-state separator. Layer 206 is negative electrode current collector layer (Ni foil). Layer 207 is an LPSI solid-state separator. Layer 208 is a positive electrode layer. Layer 209 is a positive electrode current collector layer (SDX Carbon Coated Aluminum Foil). Layer 210 is a positive electrode layer. Layer 211 is an LPSI solid-state separator. Layer 212 is the ion mill sample blade, which is part of the cutting/imaging tool.

FIG. 3 shows the interface formed between the positive electrode layer and the solid-state separator layer using the uniaxial compression process herein.

FIG. 3 shows bilayer, 300. The bilayer, 300, includes an LPSI solid-state separator layer, 301. The bilayer, 300, includes an LPSI solid-state separator layer, labeled as 301 and 302. 301 and 302 are both part of the LPSI solid-state separator layer, but they are imaged with different contrast as a consequence of the electron microscopy imaging process. The positive electrode layer is labeled 303.

### Example 2

### Testing an Electrochemical Cell Made in Example 1

An electrochemical stack, including a positive electrode, an LPSI solid electrolyte, and a lithium metal negative electrode was prepared.

The positive electrode included a mixture of NCA, LSTPS (having a milled particle size of d₅₀<1 um), and a binder cast on 12 μm aluminum foil with 5.5 mAh/cm² loading. An 8 mm electrode disc was punched and placed in a 12.7 mm die. 0.22 g of LPSI powder was poured over the electrode and the stack was pressed at 500 to 700 MPa (mega-Pascal) at 140-170° C.

A 9 mm Li anode was evaporated onto the resulting electrochemical stack (i.e., pellet). The electrochemical stack was placed in a 16 mm heated die and pressurized to around 300-600 psi (pounds-per-square inch) for testing. The physical dimensions of the electrochemical cell included a positive electrode layer diameter of 8 mm, a positive electrode layer thickness of 120 μm, a separator diameter of 12.7 mm, a separator thickness of 800 μm, a negative electrode layer diameter of 9 mm, and a negative electrode layer thickness of 30 μm.

The pellet cell was electrochemically cycled on an Arbin instrument, between 2.7-4.2V (v. Li metal). The electrochemical stack was discharged and charged at current rates of C/10 for the first, formation cycle and C/3 thereafter at 45° C. between 2.7-4.2V.

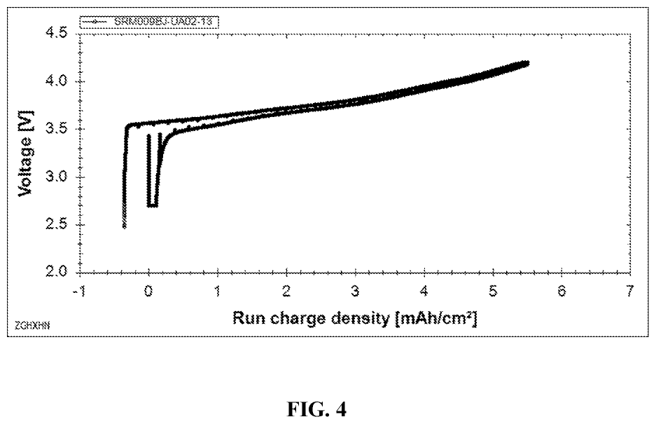

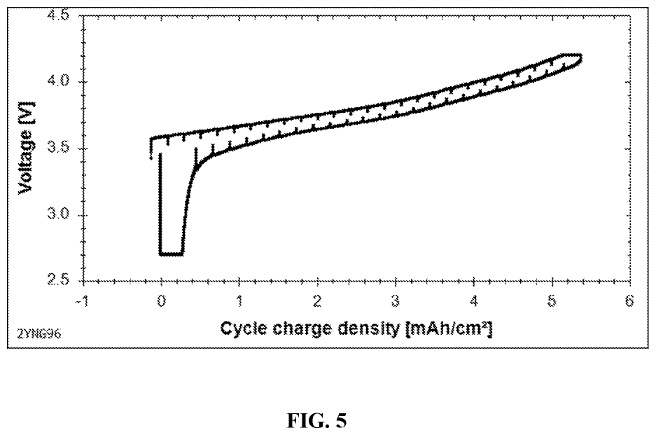

Voltage was monitored during the test, and plots of voltage versus run charge density mAh/cm² is shown in FIGS. 4-5.

In FIG. 5, the cumulative cycle index is the total number of cycles the cells have completed.

In a second test, a second electrochemical stack was discharged and charged at current rates of C/10 for the first, formation cycle and C/3 thereafter at 30° C. between 2.7-4.2V.

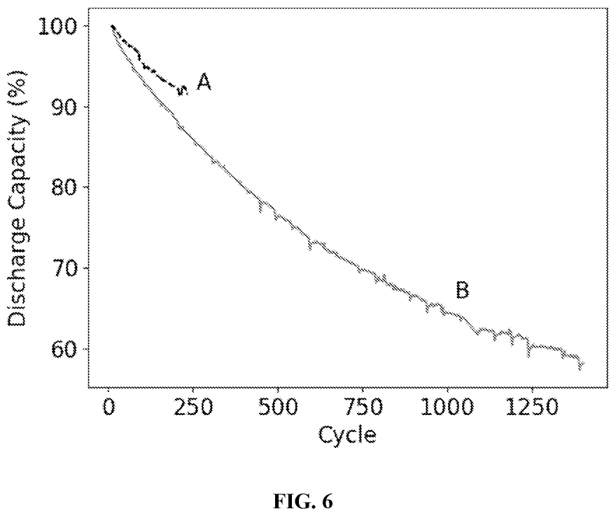

From the above tests, the plot—Energy v. cycle # —in FIG. 6 was calculated. The top curve (labeled A) is the result of the test performed at 30° C. The bottom curve (labeled B) is the result of the test performed at 45° C.

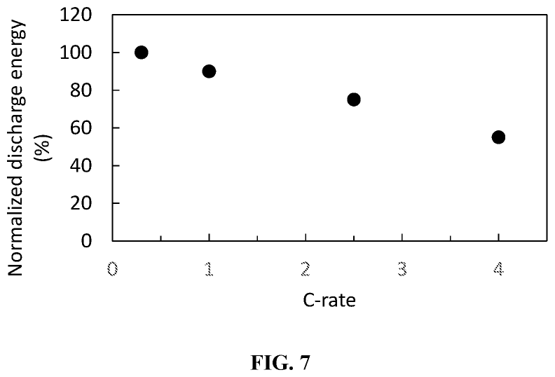

For the above samples, FIG. 7—Energy vs rate map—was calculated by discharging the cell at progressively higher rates.

This Example demonstrates that an all solid-state cell with a lithium metal anode has been made and cycled. The cell has high capacity, low impedance, and can cycle at commercially relevant current densities and high power.

The cell retains 87% capacity at 250 cycles at 45° C. and retains 93% of capacity at 250 cycles at 30° C.

The solid-state cell shows similar energy vs rate data to conventional liquid cells but has a much thicker separator. The solid-state cell architecture shows potential for exceeding conventional energy vs rate performance as the separator becomes thinner.

### Comparative Example

### Liquid Cell Under Pressure

For comparison, a cell without a solid state electrolyte was made and pressed at approximately 40 kPSI. The cell had a 4 mAh/cm² cathode with NMC, binder, carbon conductive additive, a Celgard polyolefin separator of 20 um thickness, and a lithium foil anode. The cell was soaked in an electrolyte of 1M LiPF6 with EC+EMC and assembled into a coin cell. When the full cell was pressed at 40 ksi before cycling, the cell shorted in less than 60 s. When only the cathode was pressed at 40 ksi before cycling, the cell displayed an impedance (46.3 at 45° C.) nearly three times higher than a control cell that did not have pressure applied (18.7Ω cm² at 45° C.). This example demonstrates that application of pressure is not obviously beneficial to a battery, and furthermore that only a solid state cell can withstand high pressure applied to a battery, even momentarily.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. A process for making a solid-state battery comprising:
providing at least two layered stacks;
wherein each layered stack, individually in each instance, comprises a current collector layer having at least one exposed tab and at least one member selected from the group consisting of a positive electrode layer and a solid-state separator layer; and
compressing the at least two layered stacks at a pressure in the range of 30 MPa to 5000 MPa and at a temperature of 50° C. to 250° C.

2. The process of claim 1, wherein the providing step comprises assembling a layered stack.

3. The process of claim 1 or 2, comprising compressing a surface of a positive electrode layer of one of the at least two layered stacks against a surface of a solid-state separator layer of one of the at least two layered stacks.

4. The process of any one of claims 1-3, comprising calendering at least one of the at least two layered stacks prior to the compressing step.

5. The process of any one of claims 1-4, wherein at least one layered stack comprises a current collector layer and a positive electrode layer; wherein the current collector layer is in electrical contact with the positive electrode layer.

6. The process of claim 5, wherein the current collector layer is a positive electrode current collector layer.

7. The process of any one of claims 1-6, wherein at least one layered stack comprises a current collector and a solid-state separator layer; wherein the solid-state separator layer is in electrical contact with the current collector.

8. The process of claim 7, wherein one of the at least one layered stacks comprises a negative electrode layer.

9. The process of claim 8, wherein the negative electrode layer is a lithium (Li) metal electrode layer.

10. The process of any one of claims 1-9, wherein the positive electrode layer comprises a sulfide single ion conductor and an active material.

11. The process of any one of claims 1-10, wherein the solid-state separator layer comprises a sulfide single ion conductor.

12. The process of any one of claims 1-11, wherein the solid-state separator layer comprises LPSI.

13. The process of any one of claims 5-13, wherein at least one current collector layer comprises a material selected from the group consisting of carbon (C)-coated nickel (Ni), nickel (Ni), copper (Cu), aluminum (Al), and stainless steel.

14. The process of claim 13, wherein at least one current collector layer is a negative electrode current collector layer, wherein the negative electrode current collector layer is made of a material selected from the group consisting of carbon (C)-coated nickel (Ni), nickel (Ni), and copper (Cu).

15. The process of claim 13 or 14, wherein at least one current collector layer is a positive electrode current collector layer, wherein the positive electrode current collector layer comprises a material selected from the group consisting of carbon (C)-coated aluminum.

16. The process of claim 14, wherein the negative electrode current collector layer is C-coated Ni.

17. The process of any one of claims 1-16, wherein the solid-state separator layer is rectangular shaped.

18. The process of any one of claims 1-17, wherein the positive electrode layer is rectangular shaped.

19. The process of any one of claims 1-16 wherein the solid-state separator layer is circular shaped.

20. The process of any one of claim 1-16 or 19, wherein the positive electrode layer is circular shaped.

21. The process of any one of claims 1-20, wherein the geometric surface area of the positive electrode layer and the geometric surface area solid-state separator layer are substantially the same.

22. The process of any one of claims 17-18 and 21, wherein one edge of the positive electrode layer is 10 cm in length.

23. The process of any one of claims 17-18 and 21-22, wherein one edge of the solid-state separator layer is 10 cm in length.

24. The process of any one of claims 19-20, wherein the positive electrode layer has a diameter that is 10 cm in length.

25. The process of any one of claims 19-20 and 24, wherein the solid-state separator layer has a diameter that is 10 cm in length.

26. The process of any one of claims 1-25, wherein the solid-state separator layer is a sulfide electrolyte.

27. The process of claim 26, wherein the sulfide electrolyte comprises lithium (Li), phosphorus (P), and sulfur (S).

28. The process of claim 27, wherein the sulfide electrolyte further comprises iodine (I).

29. The process of any one of claims 26-28, wherein the sulfide electrolyte further comprises a member selected from the group consisting of Tin (Sn), germanium (Ge), arsenic (As), silicon (Si), chlorine (Cl), bromine (Br), and a combination thereof.

30. The process of claim 26, wherein the sulfide electrolyte is LSTPS.

31. The process of claim 26, wherein the sulfide electrolyte is LPSI.

32. The process of any one of claims 1-31, wherein the positive electrode layer comprises a catholyte.

33. The process of any one of claims 1-32, wherein the positive electrode layer comprises a percolating network of ion conductors.

34. The process of any one of claims 1-33, wherein the solid-state separator layer comprises a percolating network of ion conductors.

35. The process of any one of claims 1-34, wherein the solid-state separator comprises a polymer-sulfide composite.

36. The process of any one of claims 1-35, wherein the positive electrode layer comprises an active material at a mass loading of about 75—about 90% by mass.

37. The process of claim 36, wherein the active material comprises a lithium intercalation material, a lithium conversion material, or both a lithium intercalation material and a lithium conversion material.

38. The process of claim 37, wherein the intercalation material is selected from the group consisting of a nickel manganese cobalt oxide (NMC), a nickel cobalt aluminum oxide (NCA), Li(NiCoAl)O₂, a lithium cobalt oxide (LCO), a lithium manganese cobalt oxide (LMCO), a lithium nickel manganese cobalt oxide (LMNCO), a lithium nickel manganese oxide (LNMO), Li(NiCoMn)O₂, LiMn₂O₄, LiCoO₂, and LiMn₂₋ₐNiₐO₄, wherein a is from 0 to 2, or LiMPO₄, wherein M is Fe, Ni, Co, or Mn.

39. The process of any one of claims 37-38, wherein the lithium conversion material is selected from the group consisting of FeF₂, NiF₂, FeOₓF₃₋₂ₓ, FeF₃, MnF₃, CoF₃, CuF₂, alloys thereof, and combinations thereof.

40. The process of any one of claim 36-39, wherein the active material is NCA.

41. The process of any one of claim 36-39, wherein the active material is NMC.

42. The process of any one of claims 1-41, wherein the positive electrode layer comprises a catholyte at a mass loading of about 10—about 25%.

43. The process of claim 42, wherein the catholyte is LSTPS or LSPSCl.

44. The process of claim 42, wherein the catholyte is LSTPS.

45. The process of claim 42, wherein the catholyte is LSPSCl.

46. The process of any one of claims 1-45, wherein the positive electrode layer comprises a carbon at a mass loading of about 0 to about 1%.

47. The process of claim 46, wherein the carbon is C65 or vapor-grown carbon fibers (VGCF).

48. The process of any one of claims 1-47, wherein the positive electrode layer comprises a binder at a mass loading of about 0 to about 2.5%.

49. The process of claim 48, wherein the binder comprises POB3.

50. The process of any one of claims 1-49, wherein the thickness of the positive electrode layer is from about 10 μm to about 500 μm.

51. The process of claim 50, wherein the thickness of the positive electrode layer is from 100 μm to about 500 μm.

52. The process of any one of claims 1-51, wherein the thickness of the solid-state separator layer is from about 1 μm to about 200 μm.

53. The process of any one of claims 1-52, wherein the thickness of the positive electrode current collector layer is from about 5 μm to about 100 μm.

54. The process of claim 53, wherein the thickness of the positive electrode current collector layer is about 15 μm.

55. The process of any one of claims 1-52, wherein the thickness of the negative electrode current collector layer is from about 5 μm to about 100 μm.

56. The process of claim 55, wherein the thickness of the positive electrode current collector layer is about 15 μm.

57. The process of any one of claims 1-56, wherein the thickness of the tabs on the current collector layer is from about 5 μm to about 100 μm.

58. The process of any one of claims 1-57, comprising compressing the at least two layered stacks at a pressure less than 600 MPa.

59. The process of any one of claims 1-57, comprising compressing the at least two layered stacks at a pressure in the range of 50 MPa to 5,000 MPa.

60. The process of any one of claims 1-59, comprising compressing the at least two layered stacks at a temperature less than 170° C.

61. The process of any one of claims 1-60, wherein the solid-state separator is made by a process which comprises milling a solid-state separator material and casting the milled solid-state separator material as a thin layer.

62. The process of any one of claims 1-61, wherein the compressing step occurs in a die.

63. The process of any one of claims 1-62, wherein the compressing step is uniaxial.

64. The process of any one of claims 1-62, wherein the compressing step is isostatic.

65. The process of any one of claims 1-64, wherein the solid-state separator comprises a polymer-sulfide composite.

66. The process of any one of claims 1-65, wherein the die comprises cut-outs for the exposed tabs.

67. The process of any one of claims 1-66, wherein two of the at least two electrochemical stacks share either a positive current collector layer or a negative current collector layer.

68. The process of any one of claims 1-67, wherein the compressing step applies both uniaxial force and isostatic force.

69. The process of any one of claims 1-68, wherein the die has at least one feature accommodating the volume of at least one current collector tab.

70. An electrochemical cell prepared by the process of any one of claims 1-69.

71. A rechargeable battery comprising the electrochemical cell of claim 70.

72. An electric vehicle comprising the electrochemical cell of claim 70 or the rechargeable battery of claim 71.
